(19) United States
(12) Patent Application Publication
(10) Pub. No.: US 2023/0382165 A1
(43) Pub. Date: Nov. 30, 2023

(54) TRAILER TIRE INFLATION SYSTEM

(71) Applicant: Equalaire Systems, Inc., Corpus Christi, TX (US)

(72) Inventors: Kevin Mark Hennig, Corpus Christi, TX (US); Benjamin Tyler Morgan, San Antonio, TX (US); Thomas C. Musgrave, IV, San Antonio, TX (US); Jonathan Gravell, San Antonio, TX (US); James Raymond Snider, Corpus Christi, TX (US); Charles Blanton Robertson, Corpus Christi, TX (US); Steven R. Miller, San Antonio, TX (US)

(21) Appl. No.: 18/030,746

(22) PCT Filed: Oct. 9, 2021
(86) PCT No.: PCT/US2021/054328

§ 371 Date: Apr. 6, 2023

Related U.S. Application Data
(60) Provisional application No. 63/149,495, filed on Feb. 15, 2021.
(60) Provisional application No. 63/090,053, filed on Oct. 9, 2020.

(51) Int. Cl. B60C 23/00

(52) U.S. Cl. CPC B60C 23/009; B60C 23/00309; B60C 23/00354

(57) ABSTRACT

A tire-inflation system for a small trailer may include a fluid pressure source mountable to the trailer, and air conduits providing sealed fluid communication between the air pressure source and the small trailer's pneumatic tires.

### CROSS-REFERENCE TO RELATED APPLICATIONS

This application claims priority to both U.S. Provisional Patent Application No. 63/090,053 titled “Small Trailer Tire Inflation System” filed Oct. 9, 2020, and U.S. Provisional Patent Application No. 63/149,495 also titled “Small Trailer Tire Inflation System” filed Feb. 15, 2021. The full disclosure of each of the aforementioned patent applications are herein fully incorporated by reference.

### FIELD

This field generally relates to tire inflation systems for towed recreational vehicles.

### BACKGROUND

This section is intended to provide a background or context to the invention that is recited in the claims. Unless otherwise indicated herein, what is described in this section is not prior art to the description and claims in this application and is not admitted to be prior art by inclusion in this section.

Many recreational vehicles (RVs) have two or more pneumatic tires requiring inflation as specified by the tire manufacturer. Such recreational vehicles may include, but not be limited to, towed vehicles utilized for the purpose of camping, temporary accommodations, tailgating, or other activities of the sort. This broad collection of towed vehicles may sometimes be referred to herein as trailers. Such trailers may be used infrequently and often have improperly inflated tires or may be prone to other problems associated with infrequently used or improperly maintained vehicles. It would, for example, be advantageous to provide systems that warn users of possible problems to components of an inflation system before such systems become damaged or where components (e.g., a spare tire) are needed in an emergency type situation. For example, detection of standing water or residual moisture in fluid supply lines or related components may initiate a warning to a user that maintenance or flushing of fluid supply lines may be desirable. Furthermore, trailers may commonly include axles such as torsion axles that may need particular modification so as to securely route fluid supply lines within or through and couple rotary union components thereto. There remains a need for a tire inflation system adapted for use in such trailers and for systems for avoiding, monitoring, and warning users of potential problems.

### SUMMARY

In some embodiments, a tire inflation system for a trailer may include at least one axle and pneumatic tires mounted at each end of the at least one axle. A fluid pressure source may be mounted to the trailer and powered by energy provided by a tow vehicle or a power source on the trailer. A level of residual moisture in fluid provided by the fluid pressure source may be controlled using an electromechanical control system. For example, the fluid pressure source may be connected to a drain valve used to divert accumulated water from the pressure source, such as to a holding tank or gray water tank of the trailer. The drain valve may, for example, be controlled by a timing circuit of the control system. In some embodiments, the drain valve may further be adjustable based on one or more sensor signals provided by or one or more water level sensors, including, for example, a capacitive sensor positioned in a drain line connected to the fluid pressure source.

It is an objective of some embodiments herein to provide a source of fluid pressure mounted to a towable trailer for use in a tire inflation system with reduced risk of contamination of components of the tire inflation system with residual water or condensate and/or other contaminants. The source of fluid pressure may be powerable by energy provided by a tow vehicle or a power source on the trailer. For example, the fluid pressure source may be an air tank coupled to an air compressor so as to receive air therefrom. One or more sensors may be disposed so as to detect the temperature and/or pressure of air provided from one or more of the air compressor and air tank. The air tank may further comprise a liquid drain valve under control of an electromechanical system control. For example, the liquid drain valve may be operatively controlled using a dump solenoid actuated by a timer circuit and/or using other suitable components or means. Purging of residual water or standing water from the air tank may help to mitigate risk of contamination of components of the tire inflation system so as to reduce risk of corrosive damage, for example.

In some embodiments, a tire inflation system for a trailer may include at least one axle and pneumatic tires mounted at each end of the at least one axle. A fluid pressure source may be mounted to the trailer and powered by energy provided by a tow vehicle or a power source on the trailer. A first fluid pathway may provide sealed fluid communication between the fluid pressure source and at least one of the pneumatic tires. The axle may comprise a torsion axle having at each end thereof a torsion arm and a spindle having one of the pneumatic tires mounted thereto, the spindle having a free end and a fixed end coupled to the torsion arm, the spindle forming a fluid channel extending from the fixed end to the free end along the central long axis of the spindle, the fluid channel being sealingly coupled to the first fluid pathway. A rotary union may be sealingly coupled to the fluid channel at the free end of the spindle and an air hose may provide sealed fluid communication between the rotary union and the pneumatic tire mounted to the spindle.

In some embodiments, a tire inflation system for a trailer may include at least one axle and pneumatic tires mounted at each end of the at least one axle. A fluid pressure source may be mounted to the trailer and powered by energy provided by a tow vehicle or a power source on the trailer. A first fluid pathway may provide sealed fluid communication between the fluid pressure source and at least one of the pneumatic tires so as to allow pressurized fluid from the fluid pressure source to flow from the fluid pressure source to the at least one of said pneumatic tires. A second fluid pathway may provide sealed fluid communication between the fluid pressure source and a spare tire of the trailer so as to allow pressurized fluid from the fluid pressure source to flow from the fluid pressure source to the spare tire.

It is an objective of some embodiments herein to provide a spare tire that may be used only infrequently and stored in a trailer, including trailers that may not be equipped with air brakes. For example, the spare tire may be placed in fluid communication with a tire inflation system fluid pressure source mounted to the trailer and powered by energy provided by a tow vehicle or a power source on the trailer. The spare tire may be automatically provided with pressurized air when needed so that the spare tire is available for immediate use. For example, the spare tire may be provided with air from a compressor such as may be prone to contamination with residual water. The tire inflation system may further be controlled so as to minimize a risk of collection of residual water or other contaminants in the spare tire. For example, an air compressor may be controlled by an electromechanical control system operated so as to automatically purge an air tank of residual water on regular intervals and/or when pressurized fluid is needed by the spare tire. It is further an objective of some embodiments herein to provide a system for detection of residual water in the spare tire or in adjacent fluid supply lines so that a user may be warned of a risk that the spare tire has unexpectedly become contaminated.

In some embodiments, a method of providing a tire inflation system for a trailer comprising an axle having a spindle at each end is provided. The trailer may, for example, be a trailer that is not equipped with air brakes, the method comprising forming an axial channel along the central axis of a spindle, the axial channel terminating at a free end of the spindle.

In some embodiments, a hubcap for a trailer is described. The trailer may, for example, be a trailer not being equipped with air brakes. The hubcap may comprise a hollow body having a first end enclosed by a face and having a second end open and adapted for coupling to a hub of the trailer by a screw threading, bolt, retainer ring, friction fit or twist lock.

In some embodiments, a tire inflation system for a trailer comprising an axle and a pneumatic tire mounted at each end of the axle is described. The trailer may, for example, be a trailer not being equipped with air brakes. The inflation system may comprise a fluid pressure source mounted to the trailer, the fluid pressure source powerable by energy provided by the vehicle or a power source on the trailer. A fluid conduit may provide sealed fluid communication between the fluid pressure source and each pneumatic tire so as to allow pressurized fluid from the trailer-mounted fluid pressure source to flow from the fluid pressure source to each pneumatic tire. An auxiliary conduit may provide sealed fluid communication between the fluid pressure source and an auxiliary air connection.

### BRIEF DESCRIPTION OF THE DRAWINGS

FIG. 1 shows a trailer including a tire inflation system coupled to a tow vehicle.

FIG. 2 shows a perspective view of the trailer shown in FIG. 1.

FIG. 3 shows a simplified view of the trailer shown in FIG. 1.

FIG. 4A is a schematic of a first embodiment of a pneumatic pathway and the associated components thereof for a vehicle inflation system for a trailer.

FIG. 4B is a schematic of a second embodiment of a pneumatic pathway and the associated components thereof for a vehicle inflation system for a trailer.

FIG. 4C is a schematic of a third embodiment of a pneumatic pathway and the associated components thereof for a vehicle inflation system for a trailer.

FIG. 4D is a schematic of a fourth embodiment of a pneumatic pathway and the associated components thereof for a vehicle inflation system for a trailer.

FIG. 5A is a schematic of a first embodiment of an electrical system of a vehicle inflation system for a trailer.

FIG. 5B is a schematic of a second embodiment of an electrical system of a vehicle inflation system for a trailer.

FIG. 6 shows an embodiment of a rotary air connection without a stator installed into a spindle.

FIG. 7 shows an embodiment of a rotary air connection with a stator installed into a spindle.

FIG. 8 shows another embodiment of a stator of a rotary air connection installed into a spindle.

FIG. 9 shows another embodiment of a rotary air connection without a stator installed into a spindle.

FIG. 10A shows a side view of an embodiment of a solid spindle of a trailer axle.

FIG. 10B shows a section view of the solid spindle of FIG. 10A adapted for use in a TIS for a straight axle.

FIG. 10C shows a section view of the solid spindle of FIG. 10A adapted for use in a TIS for a torsion axle.

FIG. 10D shows a perspective view of an embodiment of a solid spindle of a trailer axle.

FIG. 11A shows a side view of an embodiment of a recreational vehicle hubcap.

FIG. 11B shows a section view of the vehicle hubcap of FIG. 10A, exposing a threaded port in the hubcap.

FIG. 11C shows a plan view of the vehicle hubcap of FIG. 10A.

FIG. 11D shows a perspective view of the vehicle hubcap of FIG. 10A

FIG. 12 shows a set of an embodiment of torsion axles installed on a trailer body.

FIG. 13 shows an inboard view of an embodiment of a torsion axle.

FIG. 14 shows an outboard view of an embodiment of a torsion axle.

FIG. 15 shows a torsion axle with an embodiment of a rotary air connection.

FIG. 16 shows a torsion axle with another embodiment of a rotary air connection.

FIG. 17 shows a torsion axle with another embodiment of a rotary air connection.

FIG. 18 shows an embodiment of one-way valves and an air connection for external sources of a recreational vehicle.

### DETAILED DESCRIPTION

This disclosure is directed towards towable trailers, tire inflation systems for towable trailers, electronic control systems for inflation of tires on towable trailers, sensor systems for monitoring tire inflation on towable trailers, methods for installing tire inflation systems in towable trailers, and related systems and methods. Tire inflation systems described herein may, for example, include an air compressor in fluid communication with a fluid supply tank or chamber and a pressure regulator. Pressurized fluid provided therefrom may be routed to one or more tires of a towable trailer. The tire inflation systems may be particularly configured for use in towable trailers. For example, some embodiments herein may be particularly configured for communication of pressurized fluid to tires of a towable trailer by routing the fluid through shaped axles, including those designed to be used with offset torsion axles, sometimes used in RVs. Systems herein may further be used in towable trailers that may lack an air brake system or other source of pressurized fluid.

Further, in some embodiments, pressurized fluid may be particularly conditioned for use in inflation systems that may be used in RVs or other towable trailers that may be used infrequently. For example, some embodiments herein may comprise an electromechanically controlled system for minimizing and/or warning a user of the presence of residual water and/or other contaminants in fluid supply lines, such as may be used to reduce risk of corrosive or other damage to inflation system components. For example, in some embodiments, a dump solenoid for controlling a dump valve and reducing residual moisture in air provided by an inflation system may be electromechanically controlled using a timing circuit or other means.

The towable trailers described herein may include any recreational vehicle or other light-duty trailer of the sort capable of being pulled by a non-class 8 vehicle. Such RVs may be attached to a suitable tow vehicle, such as a pickup truck, a passenger car, van, SUV (sport utility vehicle), ATV (all-terrain vehicle), motorcycle, class 8 vehicle, or other vehicle capable of towing. By way of example, RVs may be attachable to such a tow vehicle by a bumper-mounted hitch ball, clevis hitch, or fifth-wheel or goose-neck hitch configuration, or any other suitable attachment mechanism. Some RVs including systems as described herein may not include a braking system or may include a brake system such as an electrically operated brake system powered by a tow vehicle, a hydraulic brake system, or a surge brake system, for example. Some embodiments of tire inflation and related systems disclosed herein may, advantageously, be applied in recreational vehicles or light-duty trailers having any brake type, including those without air brakes. It is also to be understood that the disclosed tire inflation and related systems may also be suitable for other towed vehicles besides RVs. Such vehicles may include, but not be limited to, utility trailers, horse trailers, boat trailers, or other wheeled towable trailers capable of being towed by a non-class 8 vehicle.

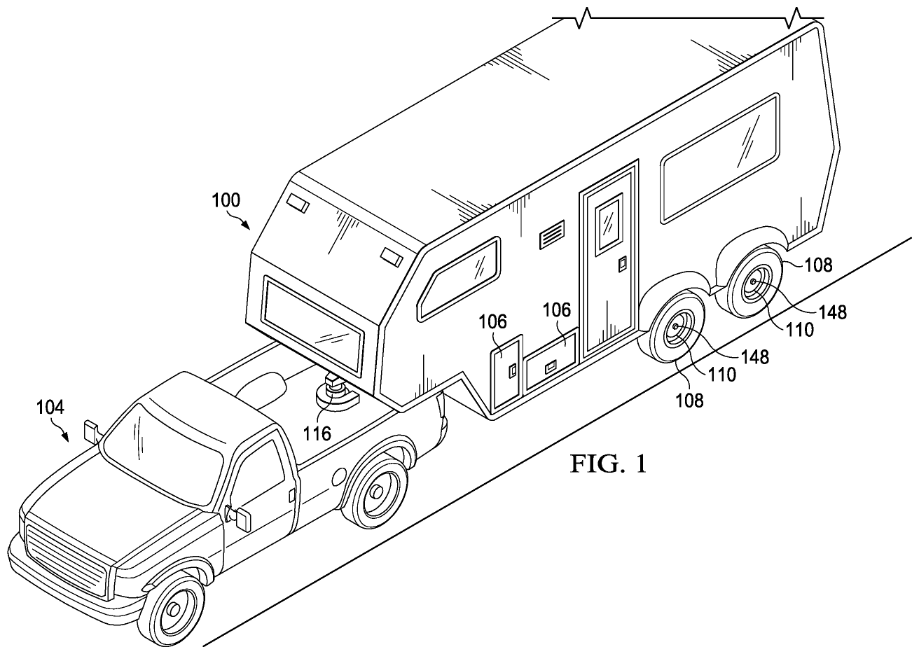

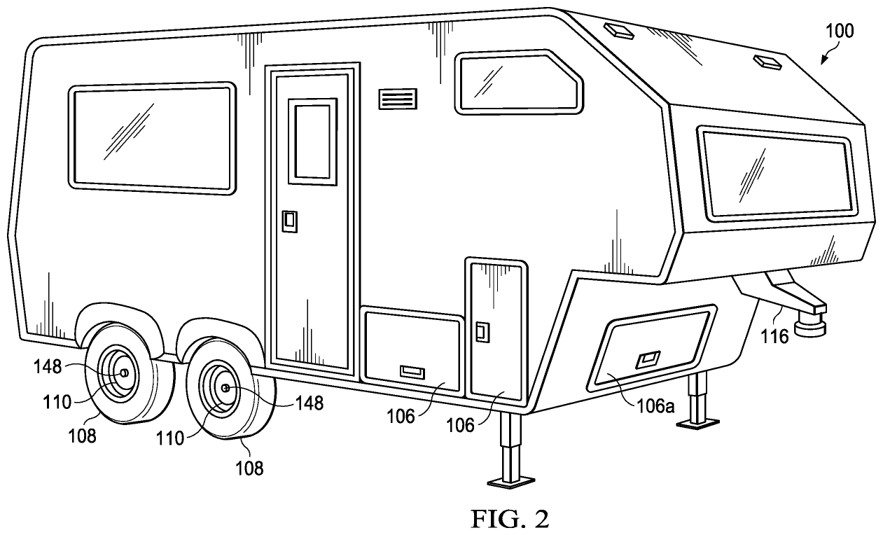

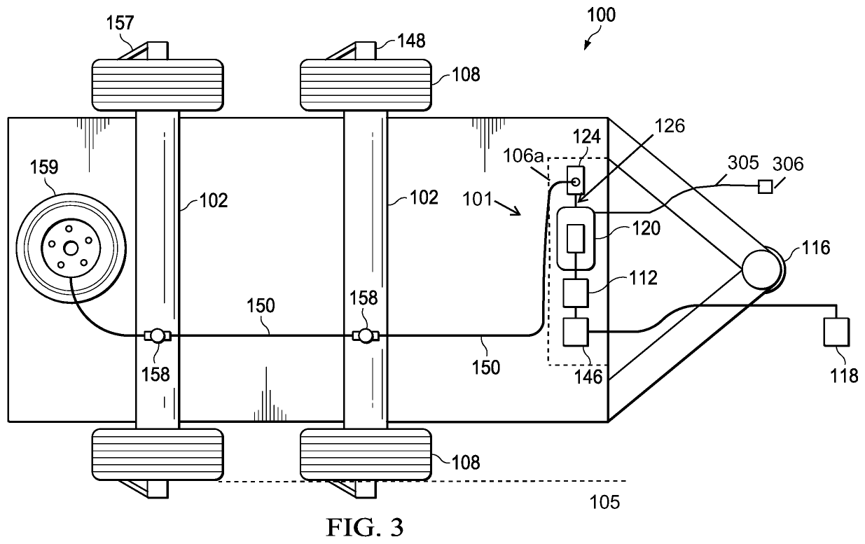

The tire inflation and related systems described herein may be installed in a towed trailer, such as the exemplary recreational vehicle (RV) 100 shown in FIGS. 1-3. As shown therein, an RV 100 may include one or more pneumatic tires 108. The RV 100 may couple to a tow vehicle 104 by means of a hitch 116 and may include one or more storage compartments 106, including forward facing storage area 106a (shown in FIG. 2). The RV 100 may include a wheel assembly at each end of one or more axles 102. The wheel assemblies of an RV may be configured in any of a variety of wheel configurations, e.g., a single-wheel configuration or dual-wheel configurations may be used. For example, as shown in FIG. 3, the RV 100 may include a pair of wheeled axles 102 wherein a pneumatic tire 108 may be mounted to each wheel of the axles 102. The tires 108 may, for example, extend outwards from the RV at a distance indicated in FIG. 3 by outboard plane 105. Each axle 102 may have one tire 108 mounted at each end of the axle 102 or may have two or more tires 108 mounted at each end of the axle 102. A hubcap 110 or grease cap may be mounted to each wheel-end on which the one or more tires 108 may be mounted, such that said hubcap 110 may substantially seal the wheel bearings (not shown) from contamination. A rotary air connection or rotary union 148 may be mounted in or near the axle 102. An air conduit 157, such as a hose, may connect to the rotary union 148 to a valve stem (not shown) of a wheel to which the pneumatic tire is mounted.

Still referring to FIG. 3, the RV 100 may be provided with a tire inflation system (TIS) 101 that uses pressurized air to maintain the tires 108 at, or fill the tires 108 to, a desired air pressure. The TIS 101 may comprise components for providing a pressurized fluid including, for example, an on-board air compressor 112, an air source or pressure supply 120, and a pressure regulator 124. The TIS 101 may further include conduits 150 and other fluid supply lines and components as further described herein for providing or conditioning pressurized fluid to the tires 108. One or more auxiliary conduits 305 may further be in fluid communication with the pressure supply 120. A valve 306 may be used to ensure that air does not leak form the auxiliary conduit 305 when the conduit is not in use. Auxiliary conduit 305 may, for example, be used to inflate recreational items, such as beach toys, ATV tires, bike tires, inflatable canopies, inflatable mattresses and cushions, and other inflatable items that might be carried or used with an RV or light duty trailer.

In some embodiments, the compressor 112 may be electrically powered. For example, compressor 112 may, for example, run from a 12V or 24V vehicle electrical system, and may be connected to a tow vehicle by an electrical connection 118. Electric air compressor 112 may be of any suitable make and model, such as Hadley 850 Series Mini Compressor, Oasis XD 3000 Extreme Duty Air Compressor, Viair 495C Air Compressor, Chassis Tech DC7000 Air Compressor, Air Zenith OB2-156 Air Compressor, Pacbrake HP625 Series Air Compressor, and Helix UltraAer Air Compressor, for example.

The pressure regulator 124 may be of any suitable type, such as model LR-1/8-D-O-mini-NPT manufactured by Festo or some models manufactured by Parker or by SMC, and may be set to pass air through at any pressure suitable for maintaining a desired tire inflation pressure. A shut-off valve 126 may be disposed inline of the system between the air source or pressure supply 120 and pressure regulator 124 so as to selectively permit or prevent fluid communication between the pressure supply 120 and the regulator 124.

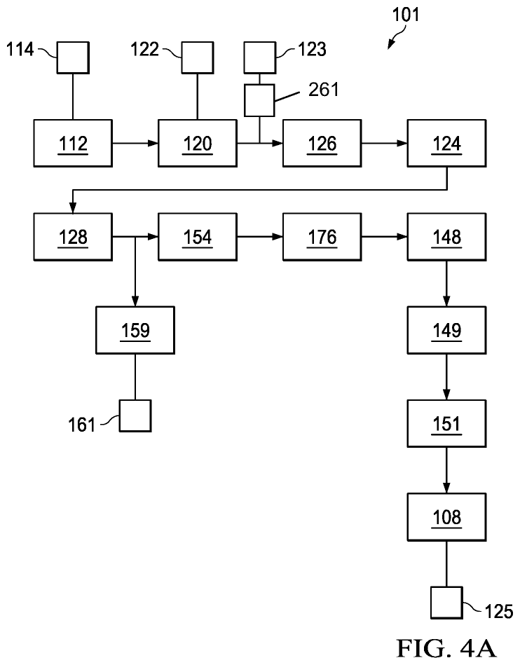

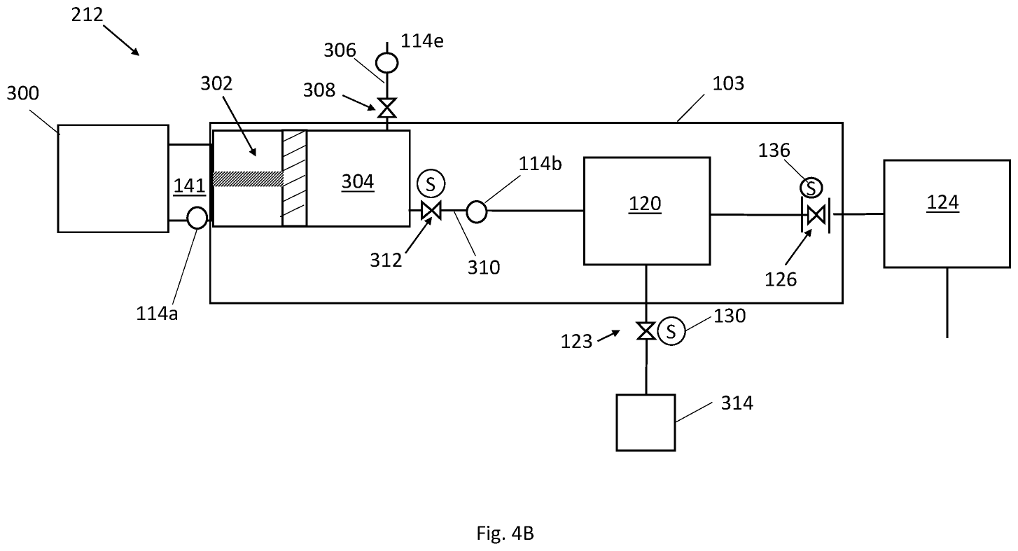

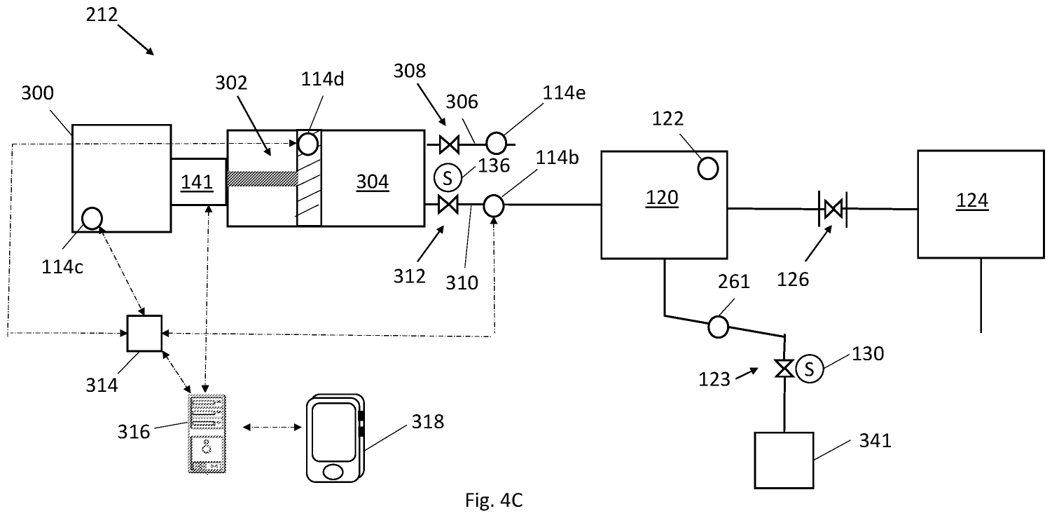

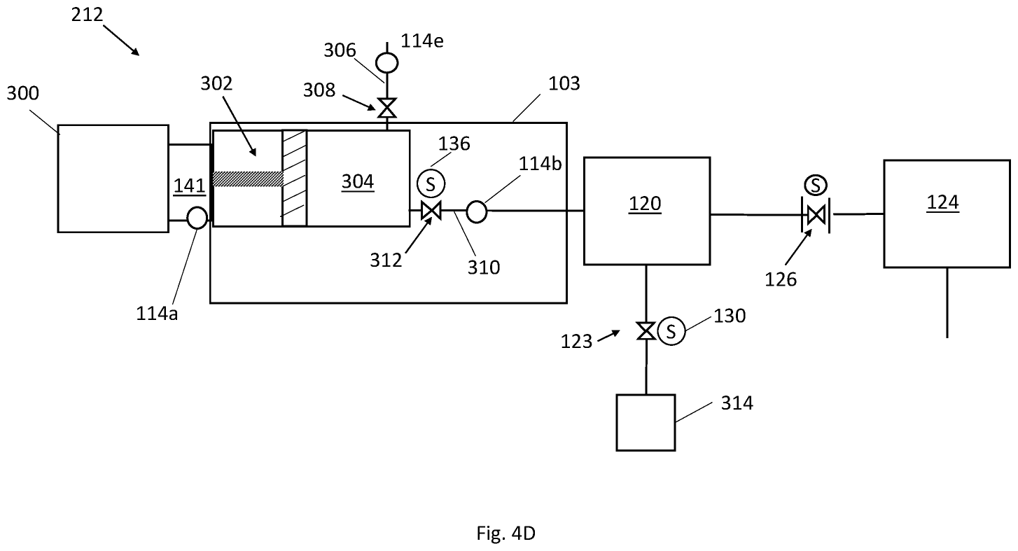

In some embodiments, one or more of the components 112, 120, and 124 may be included in a common housing. For example, the compressor 112 may include a pressure chamber suitably configured (e.g., with one or more pistons or rotating vanes) for increasing the pressure of an input source of air (e.g., atmospheric air). An integrated air source or pressure supply 120 may be commonly housed and adjacent to the pressure chamber in a compressor head region 103 (shown in FIG. 4B). Likewise, in some embodiments, pressure regulator 124 may be commonly housed together with compressor 120 and air source or pressure supply 120.

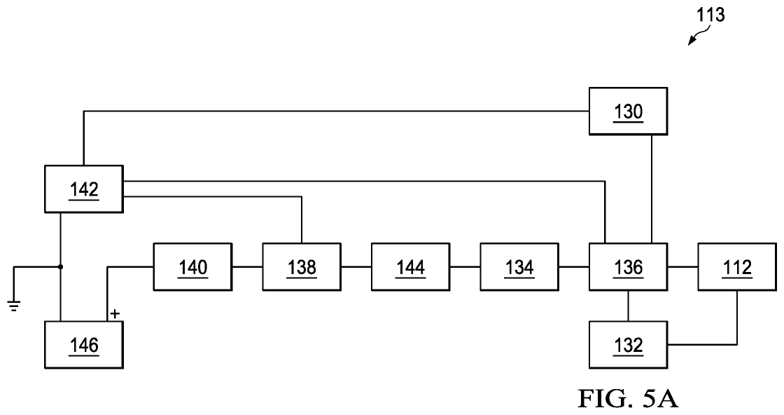

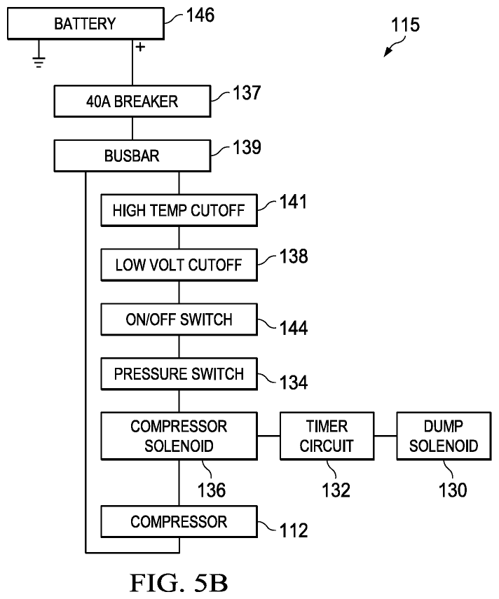

As shown in FIG. 4A, the TIS 101 may, in some embodiments, include one or more other components. For example, the TIS 101 may further include an inline dryer 128. Inline dryer 128 may be used to condition pressurized fluid by removing water vapor from the fluid so as to substantially prevent water vapor from being communicated to downstream elements of the TIS which otherwise may result in the accumulation of water in the tires 108 or in other components. From said dryer 128, the pressurized fluid may flow to the tires 108 by any of various means. For example, pressurized fluid may flow to the spindle 154 of a wheel end, or simultaneously to any one or all tires attached to the system, depending on axle configuration. The air flow may then travel through a rotary air connection or rotary union 148 to an air hose 149 in fluid communication between the rotary air connection and the valve stem of a tire 108. In some embodiments, pressurized fluid may further flow to one or more spare tires 159. The TIS 101 may further include one or more of the sensors 114, 122, 125, 161, and 261 such as may be used to measure the temperature, pressure, and/or other characteristics of the pressurized fluid or to identify standing water or residual moisture collected at different positions in the fluid pathways described herein. Particular embodiments, of the various sensors 114, 122, 125, 161, and 261 are further described in FIG. 4B-FIG. 4D. As explained therein, those sensors 114, 122, 125, 161, and 261 may be included in or provide signals fed into an electromechanical control system 113, 115, as now explained in relation to FIGS. 5A and 5B.

As illustrated in FIG. 5A (showing control system 113) and FIG. 5B (showing control system 115), a TIS may comprise an electromechanically controlled system 113, 115 for supply of pressurized fluid. For example, with particular reference to FIG. 5A, electromechanically controlled system 113 may, comprise, in addition to a compressor 112 (or compressor 212), a battery 146, dump solenoid 130, timer circuit 132, pressure switch 134, compressor solenoid 136, low voltage cutoff 138, first bus bar 140, second bus bar 142, and an ON-OFF switch 144. As shown in FIG. 5B, electromechanically controlled system 115 may comprise a compressor 112, 212 and a breaker 137, busbar 139, high-temp cutoff 141, pressure switch 134, low voltage cutoff 138, ON-OFF switch 144, timer circuit 132, compressor solenoid 136, and dump solenoid 130.

The control systems 113, 115 may be particularly configured to minimize a risk of overheating. This may, for example, be particularly important for some of the compressors 112, 212 described herein that may be suitable for use in small trailers. For example, those compressors may, at least under some conditions, be driven to provide significant output of pressurized air for extended periods of time. At least for this reason, it may be important to monitor the head temperature and/or motor temperature of the compressors 112, 212. The control systems 113, 115 may include various components to prevent overworking of the compressor 113, 115 or to shut off or idle the compressor in the even that of a temperature excursion. For example, the control system 115 is particularly configured to include a high temperature cutoff element 141. In some of those embodiments, systems herein may warn a user of a risk that a compressor 112, 212 may be overheating or otherwise experiencing or at risk of experiencing some other condition.

Viewed in the above context, as shown in the control systems 113, 115, a battery 146 may be connected to a first and second bus bar 140, 142 (as shown in FIG. 5A) for power distribution purposes with a low voltage cutoff 138 being electrically connected to the bus bars 140, 142. Or, the battery 146 may be connected to the busbar 139 (as shown in FIG. 5B). A breaker switch (as shown in FIG. 5B) may be provided between the battery 146 and the busbars 139, 140, 142 so as to protect the TIS control system in the event of high amperage or power surge. The breaker may be, for example, a 40A breaker configured to control or limit excessive power to the compressor 112, 212. The low voltage cutoff 138 may isolate the battery 146 from further discharge when the battery voltage is below an acceptable level. An ON-OFF switch 144 for engaging/disengaging TIS operation may be serially connected to the low voltage cutoff 138 and a pressure switch 134 wherein the pressure switch is serially connected to the compressor solenoid 136. In some embodiments, on/off switch 134 may allow an operator to manually control power to the TIS components and circuits. This set of switches and cutoffs may act to control the compressor solenoid 136 and thus allow compressor 112, 212 operation only under acceptable conditions. The dump solenoid 130 may be serially connected to the second bus bar 142 and compressor solenoid 136. In some embodiments, electrical connections may be configured so that the solenoids 130, 136 may operate in a coordinated matter such that only a selected one of the solenoids 130, 136 may be active at a given time. As more fully understood from the context below, dump solenoid 130 may be used to control a drain valve 123 (shown in FIG. 4A-4C) from the air source or pressure supply 120 such that accumulated water from compressor 112, 212 operation is diverted to the gray water holding tank 341 of the RV or other appropriate plumbing system.

In some embodiments, the control systems 113, 115 may be particularly configured to minimize a risk of collection of residual water within a TIS under its control. For example, as described above, some of the air compressors 112, 212 described herein may be particularly designed for use in a small trailer and may sometimes create an excessive amount of condensate water when the TIS is in operation. This may be contrasted with some other system for supplying pressure to tires, such as those that may rely on an in-line brake system where the pressure source may be protected from water vapor and/or other contaminants as may be dissolved therein and spread throughout the TIS system. Because the small-trailer pressure sources described herein may sometimes be prone to water contamination, a drain system may be disposed in the TIS system (e.g., at the compressor 112, 212 or at the air source or pressure supply 120) to prevent an excessive accumulation of water in the compressed air system. For example, as described above, a dump solenoid 130 may be used to control the drain valve 123, such as may be used to divert accumulated water to the gray water holding tank 341 of an RV or to some other appropriate plumbing system. In some embodiments, one or more additional drain valves may be disposed at some other position in the TIS system (e.g., a position wherein standing water or moisture may collect). For example, a drain valve may sometimes be positioned near the spare tire 159, or at some other location in the fluid pathways for a TIS.

In some embodiments, the control systems described herein 113, 115 may not only control operation of one or more drain systems, but may also be designed to prevent backflow of pressurized fluid during system operation. This may be particularly important because backflow of pressurized fluid may considerably increase a risk that collected standing or residual water in one part of the TIS system may be spread throughout other TIS fluid pathways. For example, in some embodiments, backflow of pressurized fluid may be controlled using a pressure switch 134. The pressure switch may, for example, be operatively controlled using pressure data from one or more pressure sensors as described herein. Coordinated activation or deactivation of the solenoids 136, 130 may further be used to help prevent uncontrolled perturbation of fluid or standing water in TIS components and to minimize risk of water from being delivered throughout the TIS system.

The timer circuit 132 may be provided to control operation of the solenoids 130, 136. In some embodiments, such a timer circuit 132 may be initiated at the start of compressor 112 operation and at a set interval send a timing signal to control the dump solenoid 130 so as to control the drain valve 123 for a prescribed time interval and thus realize the transfer of the accumulated water to the holding tank 341, or to atmosphere. Such a process may, for example, continue at the timed intervals until compressor operation 112. The timer 132 may cease operation and reset when power ceases, e.g., when on/off switch 144 is used or a high temperature condition triggered. The TIS system may, in some embodiments, be configured to prevent providing compressed air to the tires 108 when the air source or pressure supply 120 may contain residual moisture. This may, for example, be accomplished through selective operation of the compressor solenoid 136 and valve 312, operation of the shut off valve 126, or both. For example, shut off valve 126 may remain closed during one or more cycles of operation during which the drain valve 123 is open. Following completion of a cycle of transfer of accumulated water to the hold tank 341, shut off valve 126 may open and/or compressor solenoid 136 may be activated so as to allow compressed air to be provided to the tires and/or through an auxiliary connection.

In some embodiments, the TIS components and circuits may be provided as discrete components. In other embodiments, all or some of the TIS components and circuits may be integrated into a circuit, such as an ASIC. For example, the low-voltage cutoff, timer circuit and high-temperature cutoff may be provided as modules or components of an integrated circuit. The TIS components and circuits may be provided through software-based functions or as hardware components, or as any combination of hardware and software.

Additional details of the TIS 101 and control systems 113, 115 described above may be further understood in light of FIGS. 4B-4D. For example, in some embodiments, as shown in those figures, compressor 112 may be a reciprocating air compressor 212. However, other suitable types of air compressor 112, including, for example, rotating vane compressors or rotary screw compressors may sometimes be used. With reference to FIG. 4B, air compressor 212 may include motor 300, piston 302, pressure chamber 304, inlet 306, inlet valve 308, outlet 310, and outlet valve 312. The one or more sensors 114 may be disposed in thermal contact with one or more of the aforementioned components. For example, in the embodiment shown in FIG. 4B, a first sensor 114a may be disposed in thermal contact with the motor 300 so as to measure a temperature of the motor 300. A second sensor 114b may be generally positioned at the outlet of the compressor 212, such as adjacent outlet valve 312. A third sensor 114e may be positioned at the inlet to the of the compressor 212, such as adjacent inlet valve 308. In one example, the first sensor 114a may be integrated with or otherwise electrically connected to the high-temperature thermal cutoff control 141 (shown in FIG. 5A and FIG. 5B, for example). The thermal cutoff control 141 may be located at a motor/pressure chamber connection (e.g., anywhere along the chain of power transmission between the motor 300 and the compressor head 103). Motor 300 may, for example, be used to drive the compressor head 103 (e.g., via a piston 302 disposed therein) directly or through any suitable mechanism for power transmission, such as a belt, chain, or gear drive mechanism, for example. Thermal cutoff control 302 may be positioned at any suitable position to turn off or otherwise idle the motor 300 so as to substantially prevent power transmission between the motor 300 and the piston 302. In some embodiments, one or more pressure sensors may be further included among the one or more sensors 114. For example, the pressure sensor 114b may comprise a pair of sensors including a temperature sensor and a pressure sensor so that the pressure, temperature profile of air exiting a compressor 112, 212 may be determined.

Still referring to FIG. 4B, a compressor head 103 is shown. In this embodiment, the compressor head 103 may include an integrated pressure supply 120 for receiving pressurized fluid from the compressor chamber 304. In this embodiment, the compressor solenoid 136 may control the shut off valve 126. Thus, delivery of pressurized fluid from the compressor head 103 through the fluid pathway may be controlled by the compressor solenoid 136 acting on the shut off valve 126. In an alternative embodiment, as shown in FIG. 4D, a compressor head 103 may include the compressor chamber 304 and outlet valve 312, for example. However, the pressure supply 120 may comprise a separate tank. In this embodiment, the compressor solenoid 136 may control the outlet valve 312. Thus, delivery of pressurized fluid from the compressor head 103 to the pressure supply 120 may be alternatively controlled by the compressor solenoid 136.

FIG. 4C shows another embodiment of components of a TIS. In the embodiment shown in FIG. 4C, one or more temperature signals may be collected by one or more of the temperature sensors 114b, 114c, 114d, and 114e. Further, in the embodiment shown in FIG. 4C, the sensors 114b, 114c, 114d, and 114e may be configured to send signals to a receiver 314 such as may be in communication with an electronic control unit 316. The embodiment shown in FIG. 4C may, for example, be particularly configured for sending one or more high temperature notifications or other notifications or alarms to a user, as explained below.

As further shown in FIG. 4C, in some embodiments, a standing water sensor 261 may further be disposed in one or more conduits connected to the pressure supply 120. For example, a standing water sensor 261, such as a capacitive sensor may be disposed in a conduit upstream of the drain valve 123. In some embodiments, operation of the solenoids 130, 136 may further be controlled or adjusted based on one or more other signals from the sensor 261. For example, residual moisture, condensate, or standing water may be detected using the sensor 261. One or more actions may be initiated based on detection of residual moisture, condensate, or standing water. For example, a duty cycle of operation of the dump solenoid 130 or other operating parameter controlling may be modified. In some embodiments, compressed air may not be provided to the pressure regulator if standing water is detected by the sensor 261. Alternatively, compressed air may only be provided to the pressure regulator if a measured pressure (e.g., such as a pressure indicating a significant leak) at the tires 108 overrides this condition.

Temperature signals provided from the one or more sensors 114 may be used to control operation of one or more components of the TIS 101. For example, in various embodiments, any combination of the sensors 114a, 114b, and 114e shown in FIG. 4B and FIG. 4D or the sensors 114b, 114c, and 114e shown in FIG. 4C may be used. In some embodiments, in the circumstance that a compressor motor temperature or other monitored temperature exceeds a threshold temperature (which may be preset), a thermal cut-off signal may be sent to the compressor 212 (or compressor 112) so as to shut off or otherwise idle the compressor 212. For example, upon detection of a high-temperature threshold, compressor 212 may be automatically shut off or idled for a preset duration of time. Alternatively, the compressor 212 may remain shut off or idled until one or more measured temperatures drops below a suitable temperature (e.g., a temperature at the threshold temperature or a reset temperature which may be below the temperature threshold). In some embodiments, one or more other TIS 111 components different from the compressors 212 may be controlled based on a monitored temperature. For example, dump solenoid 130 or inline dryer 128 may be controlled or adjusted based on a signal provided from one or more of the sensors 114.

In some embodiments, the one or more sensors 114 may be disposed so as to sense one or more temperatures (e.g., a compressor head temperature, a motor temperature, or a temperature of air exiting therefrom) and communicate a signal representative of the one or more temperatures to a receiver unit. For example, referring to FIG. 4C, one or more temperature signals may be collected by one or more of the temperature sensors 114b, 114c, 114d, and 114e. The one or more temperature signals may be sent to a receiver unit 314. From the receiver unit 314, signals may be routed to a processor or electronic control unit 316. The receiver unit 314 and electronic control unit 316 may comprise the same structure or the components 314, 316 may be separate components provided in common or different housings. Such components 314, 316 may be in wired or wireless communication with each other. In one example, the receiver unit 314 may communicate a signal to a processor or electronic control unit 316, which may process the signal and determine a digital temperature therefrom (e.g., a compressor head temperature). Alternatively, the electronic control unit 316 may compare the signal to a reference so as to trigger one or more actions, doing so without determining an actual digital indication of temperature or providing a digital temperature reading to a user. In either case, the processor or electronic control unit 316 may initiate one or more actions including, for example, providing a temperature indication on a visual display 318, turning off or idling the compressor motor 300, or both.

In some embodiments, the one or more sensors 114, may, for example, comprise thermocouple sensors. In one example, the sensors 114 may comprise different sensing heads which may share a common thermocouple body (e.g., a common voltmeter or reference may be used for different sensing heads). Other suitable types of sensors including, for example, thermistors, and resistance temperature detectors such as resistance thermometer silicon bandgap temperature sensors, may be used in some embodiments. Visual display 318 may, for example, comprise a user display device (e.g., an iPad or phone) or a dashboard display. In some embodiments, TIS sensor data may be received by a tire pressure monitoring system (TPMS system) and provided on a visual display in connection with tire pressure information.

Air compressor 112, 212 and any sensors 114 integrated therewith may be disposed at any suitable location. For example, a suitable location for the air compressor 112, 212 may be inside a forward facing storage area 106a (FIG. 2) wherein the door of said area is disposed on the vehicle face nearest to the hitch 116 and perpendicular to the longitudinal axis of the recreational vehicle. While a front facing storage area 106a is shown in an exemplary manner as suitable for mounting of TIS system 101 components in the RV 100, any suitable storage compartment located on an RV may be utilized. The air compressor 112, 212 may be any suitable air compressor type (e.g., a reciprocating compressor, rotating vane compressor, or rotary screw compressor) and may be driven by an internal or external electrically driven motor 300. As an alternative to an electrically driven motor 300, motor 300 may be a combustion engine. If, for example, the air compressor 112, 212 is electrically driven, the compressor 112, 212 may be powered by a battery or generator mounted to the recreational vehicle 100, or may be powered by the tow vehicle 104 to which the recreational vehicle 100 is attached. An external power source, such as the tow vehicle 104 or campsite power outlet, may be utilized to charge a battery 146 for powering the TIS by means of an onboard battery charger (not shown) integrated into a TIS electrical control system, such as one of the electrical control systems 113, 115 shown in FIGS. 5A and 5B. Such a battery charger may be solely part of a TIS electrical control system 113, 115 or may be adapted for use from other RV power systems or located at the tow vehicle 104.

In some embodiments, spare tire 159 may include one or more sensors 161 such as may be disposed at or adjacent to said spare tire so as to monitor inflation conditions of said tire 159, or to measure other TIS conditions. For example, in some embodiments, a first member of the one or more sensors 161 may be a pressure sensor. A second member of the one or more sensors 161 may be a water detection sensor configured to measure a level of moisture (e.g., water vapor) or standing water that may have accumulated in the TIS system. For example, in one embodiment, one of the one or more sensors 161 may be a liquid level sensor, such as a capacitive liquid level sensor or optical sensor. In some of those embodiments, the TIS system may further be configured to send a warning to a vehicle user of detection of water vapor or standing water in the TIS system. In some embodiments, detection of standing water, as may be executed by one or more of the sensors 161, 261 may be used to control or adjust operation of a dump solenoid 130 (as described above) or to adjust other operating conditions of the TIS system 101 described herein, such as a target temperature of circulating air or a set point for in line dryer 126.

Although not shown in FIGS. 4B-4D, other components as described herein may be added in fluid communication with the pressure regulator 124. For example, as shown in FIG. 4A, in some embodiments, the pressure regulator shown in FIGS. 4B-4D may be connected to the downstream in line dryer 128. Moreover, any suitable means for connecting pressurized fluid from the regulator 124 shown therein to the tires 108 may be used. For example, pressurized air may be communicated from the regulator 124 shown in FIGS. 4B-4D to the axles 102 of the RV 100 as shown in FIG. 3. The axles 102 may, for example, be hollow axles used to communicate fluid to the tires 108. More generally, pressurized air may be provided from a pressure supply 120 to the axles 102 using the air conduit 150 through one or more intermediate structures as may be included in various embodiments described herein. For example, pressurized air may be provided to the axles 102 upon exiting any of the shut-off valve 126, pressure regulator 124, inline dryer 128, or another air distribution element, such as may be directly upstream of the axles 102 in particular embodiments. Embodiments herein may further route pressurized air through or along any of various different types of axles, as described below. For example, an overall fluid pathway for providing fluid to the tires 108 may include the air conduit 150 and other fluid connections such as may comprise the axles 102 or other fluid connections routed adjacent or through the axles 102.

Some towable trailers, as shown for RV 100, may include hollow axles 102 that may be sealed at each end by a cap or plug, such as those described in one of U.S. Pat. Nos. 5,769,979, 6,131,631, 6,394,556, 6,892,778, and 6,938,658, or by any other suitable threadable cap or insertable axle plug. Further, as disclosed in each of U.S. Pat. Nos. 6,325,124 and 7,273,082, a cap or plug may serve to support air conduits, or rotary union 148 components supported therein. A cap or plug may be used to seal the axles 102, so that air conduit 150 may be sealingly connected between pressure regulator 124 and the sealed, hollow axles 102. Thus sealed, each axle may serve as part of the overall fluid pathway to communicate pressurized air to the tires 108. In other embodiments, an air conduit 150 may be provided from a compressed air source 120 through the hollow axles without need for sealing the axles.

Other towable trailers may include solid axles. In such embodiments, an axial hole may be drilled in the axles, as described, and the axles may be further sealed with a stator or with a plug as described above. Alternatively, an air conduit may be provided through the hole drilled in the solid axle without need for sealing the axle.

Thus, in some embodiments, one or more recreational vehicle axles may be hollow sealed axles 102. The axles 102 may be hollow and may be sealed to serve as part of a conduit for pressurized air. An air conduit 150 may be sealingly connected to the axle 102 to allow pressurized air to flow from the air compressor 120 or pressure regulator 124 to the axles 108. The pressurized air may flow through the axles 102 to a rotary air connection 148 mounted in or near the axle end as described in more detail below. An air conduit 157, such as a hose, may connect to the rotary air connection or rotary union 148 to a valve stem of a wheel to which the pneumatic tire is mounted, thus allowing pressurized air to flow to and/or from the tire. In some embodiments, the air conduit 150 may be sealingly connected to a tee 158 to allow pressurized air to flow to a second axle or other downstream tire such a spare tire 159.

An air conduit may, in other embodiments, be disposed in the trailer axle. The axle may carry an air conduit to communicate pressurized air to a rotary connection, for example, such as is disclosed in U.S. Pat. Nos. 6,325,124 and 7,273,082. Air hoses may connect the rotary connection to the valve stem of the wheel to which the pneumatic tire is mounted, thus allowing pressurized air to flow to and/or from the tire. In other embodiments, if the axle is solid, then a channel may be bored in the axle to permit positioning of all or part of the conduit inside the axle.

The TIS may further comprise a rotary air connection or rotary union 148 mounted on or in the wheel-end assembly to allow communication from an air source to the rotatable tires so as to allow pressurization of the tires. Suitable rotary air connections (rotary unions), and other suitable TIS components, may include those disclosed, for example, in U.S. Pat. Nos. 5,377,736, 6,698,482, 6,105,645, 6,325,124, 6,325,123, 7,302,979, 6,269,691, 5,769,979, 6,668,888, 7,185,688, 7,273,082, 6,145,559, 6,425,427, 7,963,159, 10,471,782 and U.S. Pat. Pub. No 2009/0266460, the disclosures of which are incorporated herein by reference. Thus, any suitable rotary coupling may be used to communicate air between the air source and the rotatable tires. For example, with respect to U.S. Pat. No. 5,769,979, a stator may be mounted in a hollow or axially-drilled axle. In some embodiments, a stator may be mounted in a cap or plug sealing an axle, such as the one described above, or affixed to the end of an air conduit provided through a hollow or axially-drilled axle. Alternatively, with respect to U.S. Pat. No. 10,471,782 a rotary coupling may include a rotary air connection directly mounted in an axially-drilled channel of an axle.

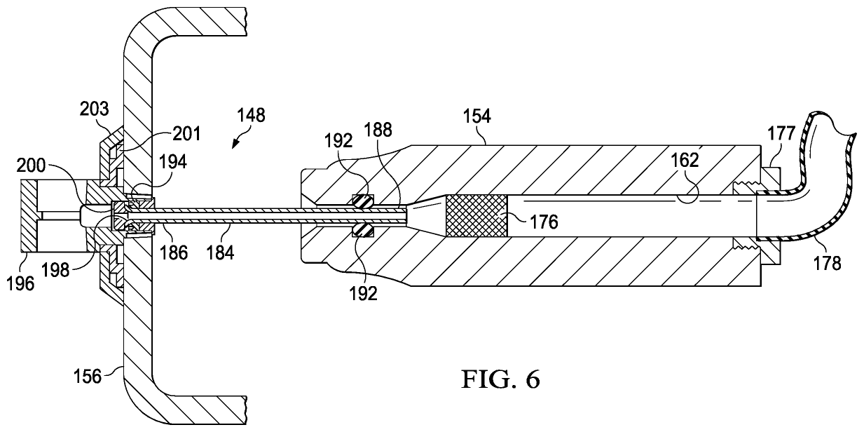

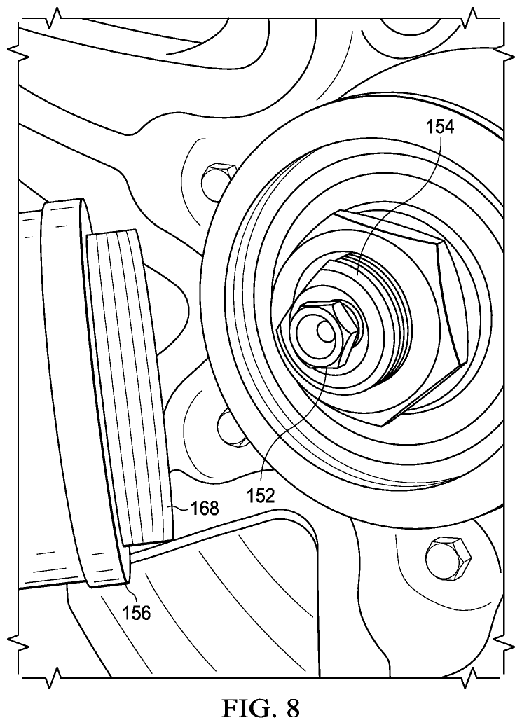

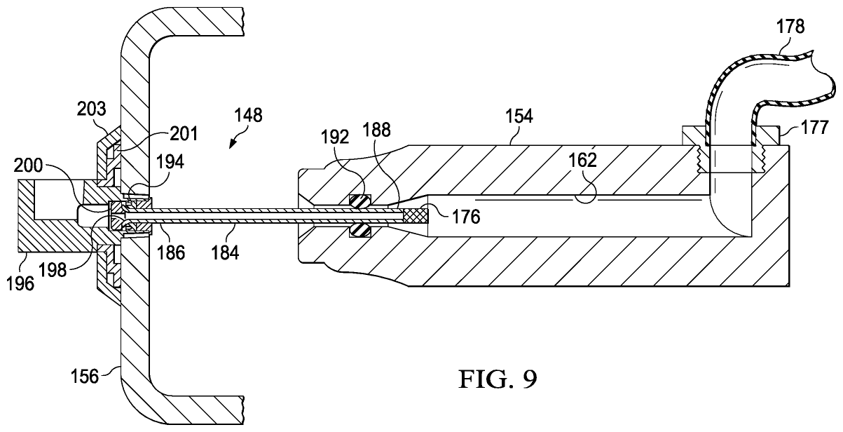

For example, as shown in FIG. 6, a rotary air connection or rotary union 148 may be mounted to a rotating wheel, such as on a hub or a grease cap 156. Air conduits or hoses 157 (shown in FIG. 3) may be sealingly provided between the rotary union 148 and the tires 108. The rotary union 148 may include a rotatable part including a tubular member 184 having a first end 186 and a second end 188. The second end 188 of the tubular member 184 may be coaxially extendable through and longitudinally movable in the axial channel 162, and may sealably engage a first annular seal 192 disposed in the axial channel 162 so as to allow sealed fluid communication through air conduit 178. A filter 176 may be disposed in the channel 162. Alternatively, as shown in the related embodiment shown in FIG. 9, the filter 176 may be disposed at the end 188 of the tubular member 184.

The first annular seal 192 may provide a rotating or non-rotating seal and a pivotable or non-pivotable sealing engagement with the tubular member 184. For example, depending on the configuration of the first annular seal 192, the tubular member 184 may or may not rotate in the seal 192. The first end 186 of the tubular member 184 may be sealably connected through a second annular seal 194 to an air connection 196 or tee-body mounted on the hub cap 156. The second annular seal 194 may provide a rotating or non-rotating seal and a pivotable or non-pivotable sealing engagement. For example, depending on the configuration of the second annular seal 194, the tubular member 184 may or may not rotate in the seal 194. However, the tubular member 184 should be permitted to rotate in at least one or the other of annular seals 192 and 194, if not in both. Furthermore, the tubular member 184 may be rigid, or flexible, or may include both a flexible portion and a rigid portion. The tubular member 184 may include a flexible joint or coupling. The annular seals may comprise o-rings, washers, lip seals, face seals, or any suitable sealing interface, and may comprise a variety of materials, such as rubber, silicone, graphite, and steel or any other suitable sealing material or interface.

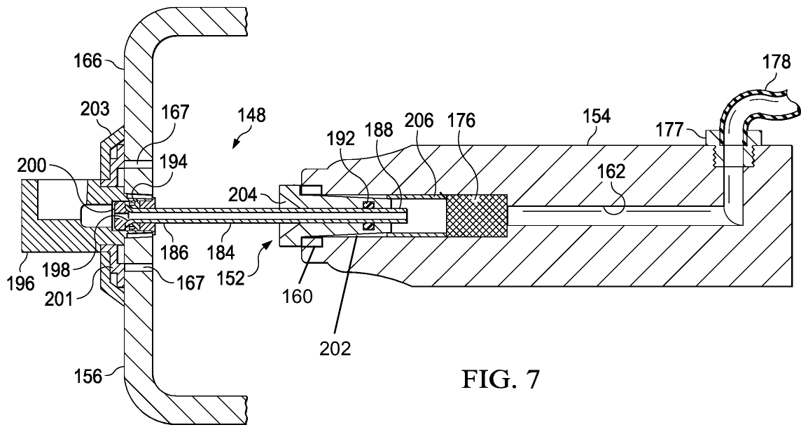

In some embodiments, such as seen in FIG. 7, a stator 152 may be disposed in the outboard end of a wheel-end spindle 154 and thus protected by a hubcap or grease cap 156. A rotary air connection or rotary union 148 may be mounted to the rotating wheel, such as on a hub or grease cap 156, and air conduits 157 (shown in FIG. 3) may be sealingly provided between the rotary connection or rotary union 148 and the tires 108.

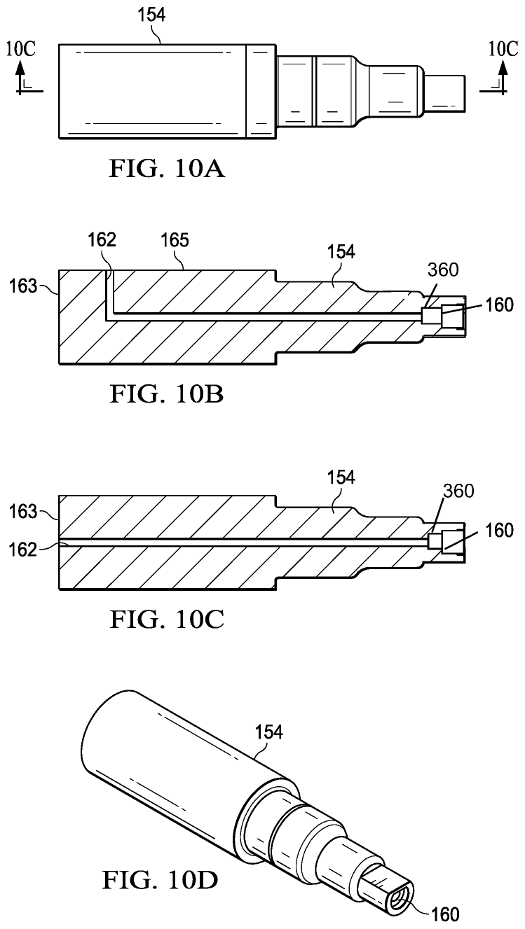

The stator 152 may be sealingly disposed in the air channel or axial channel 162. The stator 152 may comprise a stator body 202 and a head 204, the stator body 202 extending into the axial channel 162 along the central axis. For example, the stator head 204 may extend within the counterbore region 160 (also shown in FIGS. 10A-10D) of the spindle 154. An annular seal 192 may be disposed to prevent leakage of fluid between the stator and tubular member 184 having a first end 186 and a second end 188. The second end 188 of the tubular member 184 may be rotatably or non-rotatably disposed therein. A stator tube 206 may be sealingly affixed to the stator, and a filter 176 may be disposed at the end of the stator tube 206. Pressurized fluid may pass from the conduit 178 into the air channel or axial channel 162, through the filter 176 and into the tubular member 184 through the air connection 177. The rotary air connection or rotary union 148 shown in FIG. 7 may include a rotatable part including the tubular member 184. The second end 188 of the tubular member 184 may be coaxially extendable through and longitudinally movable in the stator 152, and may sealably engage a first annular seal 192 disposed in the stator body 202 so as to allow sealed air communication with the air source or pressure supply 120 through air conduit 178.

As similarly described in relation to the embodiment shown in FIG. 6, first annular seal 192 may provide a rotating or non-rotating seal and a pivotable or non-pivotable sealing engagement with the tubular member 184. In other words, depending on the configuration of the first annular seal 192, the tubular member 184 may or may not rotate in the seal 192. The first end 186 of the tubular member 184 may be sealably connected through a second annular seal 194 to an air connection 196 or tee-body mounted on the grease cap or hubcap 156. The second annular seal 194 may provide a rotating or non-rotating seal and a pivotable or non-pivotable sealing engagement. In other words, depending on the configuration of the second annular seal 194, the tubular member 184 may or may not rotate in the seal 194. However, the tubular member 184 should be permitted to rotate in at least one or the other of annular seals 192 and 194, if not in both. Furthermore, the tubular member 184 may be rigid, or flexible, or may include both a flexible portion and a rigid portion. The tubular member 184 may include a flexible joint or coupling.

The air connection 196 may be provided on the grease cap or hubcap 156 for communicating air to the tire or tires 108 via an air hose 157 connected to the wheel valve stems (not shown). The first end 186 of the tubular member 184 may include a shoulder 198 that co-acts with a bearing 200. In operation, air may be supplied to the tires through the rotary air connection or rotary union 148. The grease cap or hubcap 156 and air connection 196 may rotate with the tires 108 relative to the wheel spindle 154. The tubular member 184 may rotate, as well, in some embodiments. Air may flow from the air source or pressure supply 120 through a filter 176 into the tubular member 184 of the rotary air connection or rotary union 148 to the air connection 196. Said filter may be removably disposed in the air channel or axial channel 162 and integrated into the stator 152. Alternately, said filter may be an independent body wherein the end of the stator body 202 abuts or slightly nests into the filter end. Air may flow from the air connection 196 through air hoses 157 and tire valves 151 into the tires. Of course, if the tire inflation system provides for tire deflation, air may flow in the reverse direction from that just described. The rotary air connection or rotary union 148 may further comprise a hubcap vent shield. The grease cap or hubcap 156 may have one or more over-pressurization vents 167 disposed through the outboard face 166 of the hubcap to allow excess pressure to escape. Such a shield may prevent lubrication from spraying on the exposed rotary connection components in the event of a hubcap over-pressurization event. Such a shield may comprise a semi-rigid internal flapper 201 which covers vent holes 167 in the hubcap and an outer rigid cover 203 that aids in protecting said flapper. In the event of pressure release, the air escaping past the flapper may cause the flapper to vibrate violently, thus emitting a high-pitched noise to warn the driver of a pressure leak in the TIS.

Of course, any suitable rotary connection may be provided. In other embodiments, air conduits may be routed for external attachment to a rotary union mounted to the trailer wheels. In such embodiments, air conduits may be routed from the air source or upstream component next closest to the rotary union through brackets mounted to the trailer, such as to the tire fenders. The air conduits may be sealingly connected to rotary unions mounted to the RV wheels.

For an axle or spindle that accepts a stator 152 (e.g., as in FIG. 7 and FIG. 8), the stator 152 may be generally countersunk at the accepting end of the component to which the stator is mounted so as to maintain the then connecting rotary air connection or rotary union 148 inside or near to the outboard plane 105 of the tire (shown in FIG. 3). The countersinking may be enabled by a counterbore region 160 (shown in FIG. 10C, for example) at the outboard end of the spindle. It is desirable for the hubcap or grease cap 156 of the wheel-end to be configured so as to maintain the rotary union within the outboard plane 105 of the tire, and thus the counterbore recess enables such a hubcap to be utilized. In some embodiments, the cavity formed by such a counterbore operation may be of a size sufficient to accept a socket wrench or other such tool.

In some embodiments, such as shown in FIG. 9, a rotary air connection may be provided for supplying air from an air pressure supply in a tire inflation system through one or more air hoses to a rotating tire (not shown). A hubcap or grease cap 156 may be provided at each wheel spindle 154 for retaining lubricant in or protecting the wheel bearings (not shown). An air conduit 178 may supply air to the rotary air connection or rotary union 148 through a central air channel or axial channel 162 in the wheel spindle 154 by coupling to an air connection 177. Said channel may be along the central longitudinal axis of the spindle until exiting adjacent to the inboard end of the spindle and thus said exit being on the spindle outer face parallel to the central longitudinal axis. The rotary air connection or rotary union 148 may be supported and positioned in the center end of the wheel spindle 154, and may sealingly engage the interior of the wheel spindle 154 if pressurizing air is injected directly into the air channel or axial channel 162 of the wheel spindle 154.

The rotary air connection or rotary union 148 may include a rotatable part including a tubular member 184 having a first end 186 and a second end 188. The second end 188 of the tubular member 184 may be coaxially extendable through and longitudinally movable in the spindle air channel or axial channel 162, and may sealably engage a first annular seal 192 disposed in the spindle air channel or axial channel 162 so as to allow sealed air communication with the air source or pressure supply 120 through air conduit 178. The spindle air channel or axial channel 162 may narrow at the outboard end of the spindle so as to sealingly accept the second end 188 of the tubing member 184. Annular seal 192 may be disposed in said narrowed section of the air channel or axial channel 162.

The first annular seal 192 may provide a rotating or non-rotating seal and a pivotable or non-pivotable sealing engagement with the tubular member 184. In other words, depending on the configuration of the first annular seal 192, the tubular member 184 may or may not rotate in the seal 192. The first end 186 of the tubular member 184 may be sealably connected through a second annular seal 194 to an air connection 196 or tee-body mounted on the grease cap or hubcap 156. The second annular seal 194 may provide a rotating or non-rotating seal and a pivotable or non-pivotable sealing engagement. In other words, depending on the configuration of the second annular seal 194, the tubular member 184 may or may not rotate in the seal 194. However, the tubular member 184 should be permitted to rotate in at least one or the other of annular seals 192 and 194, if not in both. Furthermore, the tubular member 184 may be rigid, or flexible, or may include both a flexible portion and a rigid portion. The tubular member 184 may include a flexible joint or coupling. The annular seals may comprise o-rings, washers, lip seals, face seals, or any suitable sealing interface, and may comprise a variety of materials, such as rubber, silicone, graphite, and steel or any other suitable sealing material or interface.

The air connection 196 may be provided on the grease cap or hub cap 156 for communicating air to the tire or tires 108 via an air hose 157 connected to the wheel valve stems (not shown). The first end 186 of the tubular member 184 may include a shoulder 198 that co-acts with a bearing 200. In operation, air may be supplied to the tires through the rotary air connection or rotary union 148. The grease cap or hubcap 156 and air connection 196 may rotate with the tires 108 relative to the wheel spindle 154. The tubular member 184 may rotate, as well, in some embodiments. Air may flow from the air source or pressure supply 120 through a filter 176 into the tubular member 184 of the rotary air connection or rotary union 148 to the air connection 196. Said filter may be removably attached to said tubular member at the second end 188 and reside in the larger portion of the spindle air channel or axial channel 162. Air may flow from the air connection 196 through air hoses 157 and tire valves 151 into the tires. Of course, if the tire inflation system provides for tire deflation, air may flow in the reverse direction from that just described. The rotary air connection or rotary union 148 may further comprise a hubcap vent shield. Such a shield may prevent lubrication from spraying on the exposed rotary connection components in the event of a hubcap over-pressurization event. Such a shield may comprise a semi-rigid internal flapper 201 which covers vent holes in the hubcap and an outer rigid cover 203 that aids in protecting said flapper.

As shown in FIGS. 10A-10D, a solid spindle 154 may have a counterbore region 160 at the outboard end of said spindle with an air channel or axial channel 162 both drilled along the central longitudinal axis of said spindle wherein said channel may act as a fluid conduit through said spindle. The counterbore region 160 may be deep enough to sink the stator head 204 partially or fully into the end of the axle. The spindle may further have a stator bore 360. For spindles utilized with straight axles, as seen in FIG. 10B, the air channel or axial channel 162 may exit adjacent to the inboard face 163 of the spindle and thus said exit being on the spindle outer face 165 parallel to the central longitudinal axis. For spindles utilized with offset axles (torsion axles), as seen in FIG. 9C, the air channel or axial channel 162 may continue fully along the central longitudinal axis and thus exit at the inboard face 163 of the spindle.

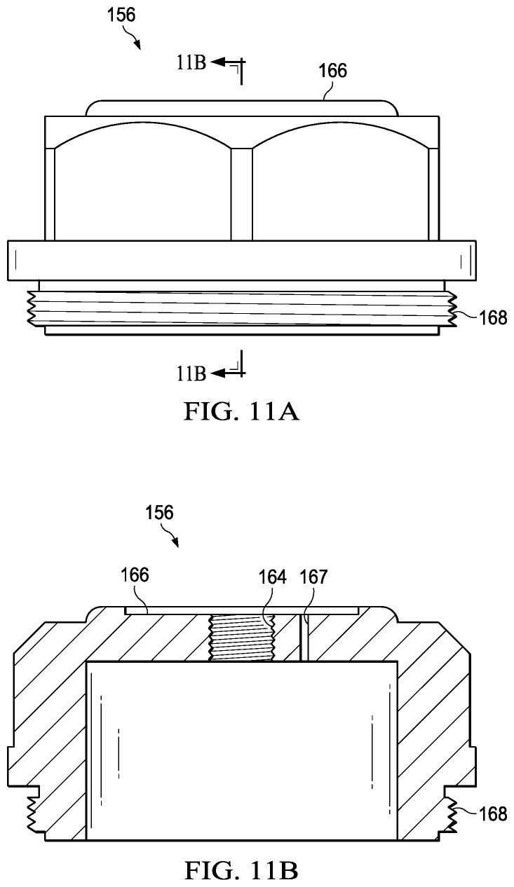

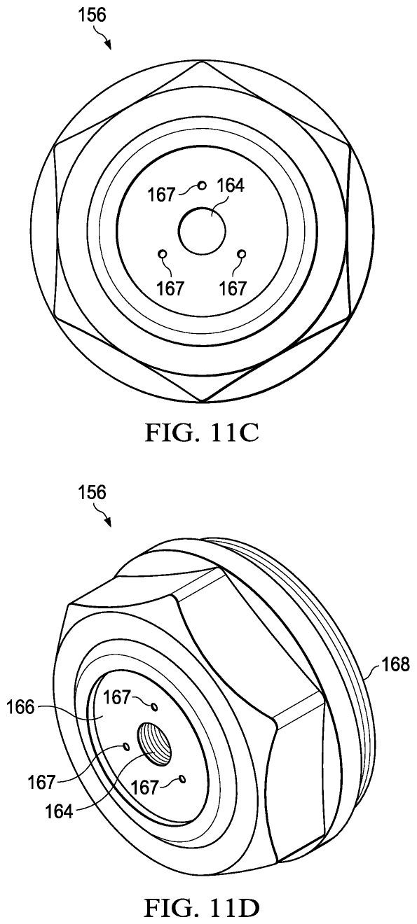

As shown in FIGS. 11A and 11B, the hubcap 156 of the RV may have a threaded port 164 tapped into the center of the outboard face 166 of said hubcap wherein said port may accept a rotary air connection or components thereof. The hubcap may be coupled to the wheel-end by a threaded connection 168. For such embodiments, the wheel hub is correspondingly threaded to receive the hubcap. The threaded connection may be desirable over push-on connections so as to better retain the hubcap to the wheel hub in the event of a wheel-end pressurization event. In other embodiments, a hubcap may be coupled to the wheel hub by bolts, or friction fit, retainer ring, or twist lock. As seen in FIGS. 11C and 11D, the grease cap or hubcap 156 may have one or more over-pressurization vents 167 disposed through the outboard face 166 of the hubcap. Said vents may allow the hubcap to expel any excess pressure formed in the event of the hubcap interior becoming pressurized. A pressurization of the hubcap may be undesirable and be caused by a leak or other such failure of the inflation system.

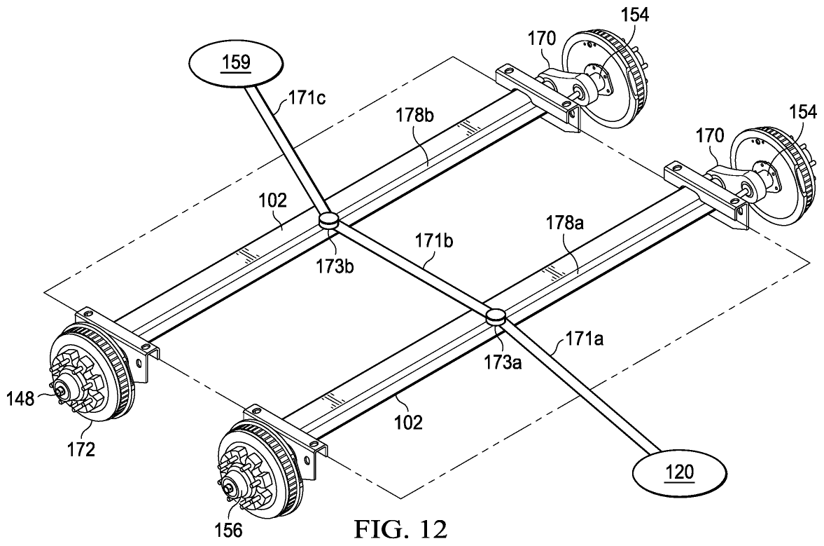

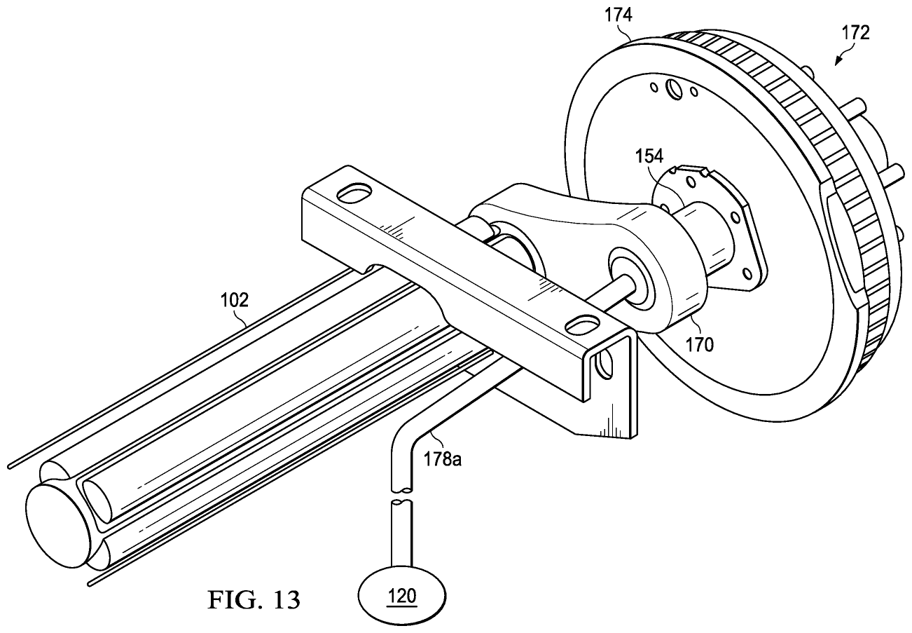

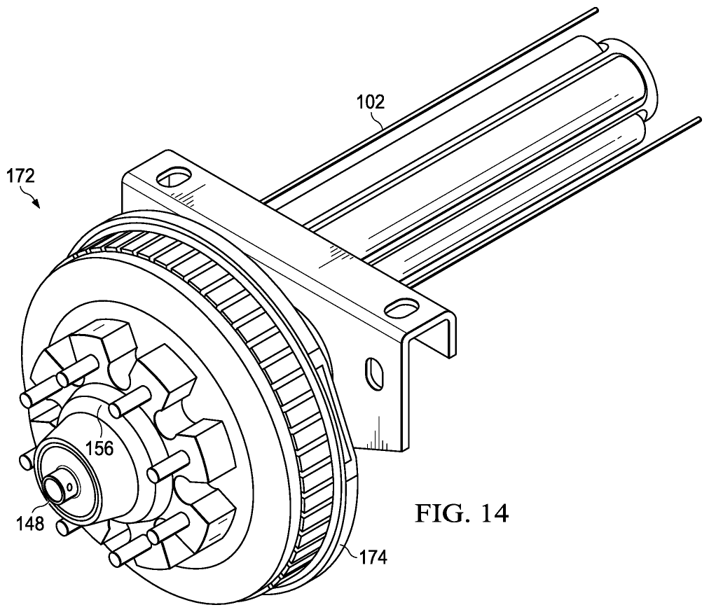

As seen in FIG. 12-14, some towed recreational vehicles may use torsion axle suspension systems. In such a system, an axle 102 is provided whereat each end is disposed a torsion arm 170 and a wheel-end 172 disposed at the opposite end of the torsion arm as is the axle. Said wheel-end may include a spindle 154 on which is mounted the wheel hub 174 on which is further mounted a pneumatic tire (not shown). Said spindle may then be coupled at or adjacent to the distal end of said torsion arm and accept a rotary air connection or rotary union 148. Such a spindle may be a straight spindle or a tapered spindle. As with the aforementioned axles, the axle may be hollow or solid and adopt the aforementioned means of routing air through or along the axle.

In the embodiment of FIG. 12, air source or pressure supply 120 is in fluid communication with the axles 102 through a system of fluid conduits, such as air hoses. A first air hose 171a connects the air source 120 to a first air distribution connection 173a. A wheel-end air conduit 178a is in fluid communication with the first air distribution connection 173a. The wheel-end air conduit 178a is routed to a spindle 154 at a torsion arm 170. A second air hose 171b may provide fluid communication from distribution connection 173a to a second distribution connection 173b. The wheel-end air conduit 178b is in fluid communication with the second air distribution connection 173b. The second air distribution connection 173b is disposed at a second axle and connects to a set of wheel-end air conduits 178b for the second axle. A third air hose 171c may provide fluid communication from the second distribution connection 173b to the spare tire 159. The series of air hoses 171a, 171b, and 171c and air distribution connections 173a, 173b may be repeated for any number of axles present on the trailer. Alternately, an air conduit 178a, 178b may be connected directly to the air source or pressure supply 120 and wherein there is an equivalent number of air conduits 178a, 178b as there are tires 108 on the RV.

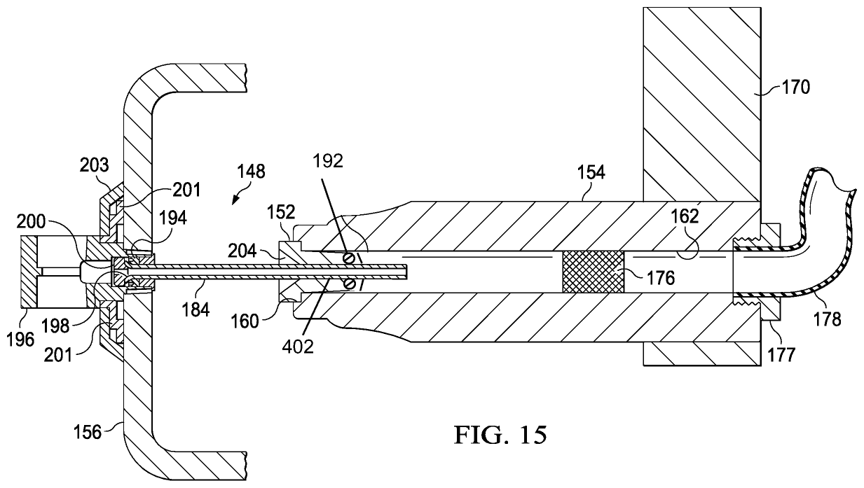

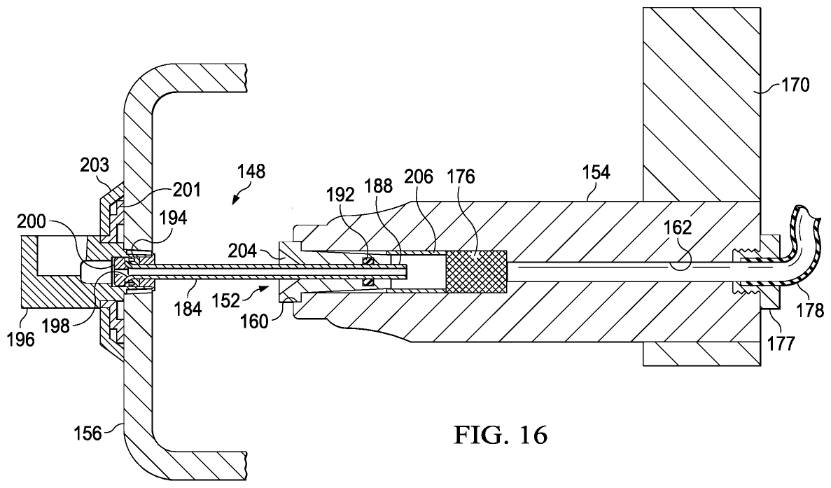

Referring to FIGS. 15-17, the spindle 154 for an offset axle may be hollow or have an air channel or axial channel 162 drilled through the spindle body along the central longitudinal axis. A filter 176 may be disposed inside said channel so as to prevent from reaching the rotary union any contaminants, such as dirt, rust, metal shavings, or other particulate type matter as may be found in the system. At the inboard terminus of said conduit, a wheel-end air conduit 178 may attach to the spindle by means of an air connector 177 disposed at the inboard face of the spindle and in fluid communication with the air channel or axial channel 162. The opposing end of the air conduit 178 may couple to an air connector on the axle 102 as appropriate with the style of axle in use, thus forming an air communication path between the axle based air conduits and the spindle based air conduits. The air conduit 178 may be a hose, rigid tubing, semi-rigid tubing, or other form of conduit conducive to use in an area exposed to the elements and potential chemicals as typically associated with a suspension system or road spray.

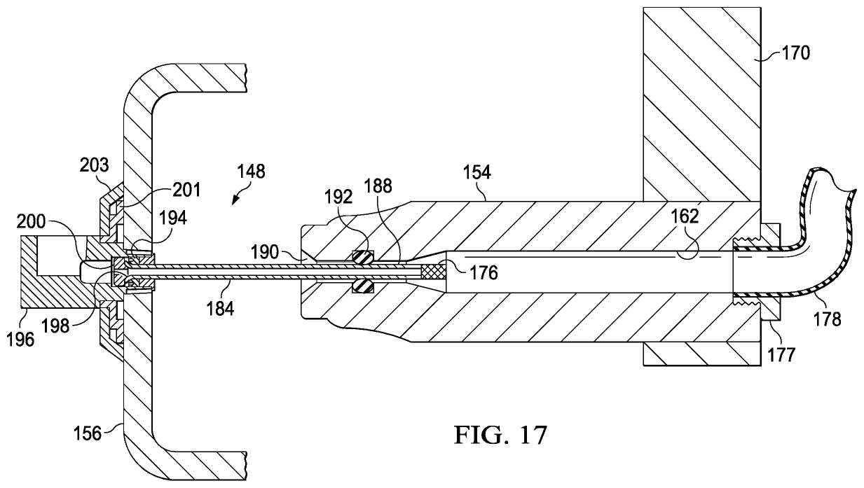

In some embodiments, such as in FIG. 15, the air channel or axial channel 162 may be of a constant diameter to sealably accept a stator 152 into the counterbore area 160 and said channel. A filter 176 may be disposed in a removable manner along the spindle air channel or axial channel 162. The stator may include an axial bored channel 402 to sealingly accept the tubular member 184. A seal may be formed by an annular seal 192 disposed at the bored channel 402. In some other embodiments, such as in FIG. 16, the internal air channel or axial channel 162 may be of one diameter at the inboard region of the spindle 154 and terminate at the outboard region of the spindle in a larger diameter. In such an embodiment, the filter 176 may be disposed at the inboard terminus of the larger diameter section of said channel as a component of the stator 152 or as a separate component into which the end of the stator may nest. In yet other embodiments, such as in FIG. 17, the air channel or axial channel 162 may be of a larger diameter toward the inboard region of the spindle 154 and be of a lesser diameter toward the outboard region of said channel. Such a smaller diameter region may be suitable for the installation of an annular seal 192 to accept tubular member 184 from the rotary union wherein such internal seals negate the requirement of a stator 152. In such an embodiment, a counterbore area 190 may be bored into the outboard most end of said spindle so as to prevent the member 184 from binding under a shift in position between the spindle 154 and grease cap or hubcap 156.

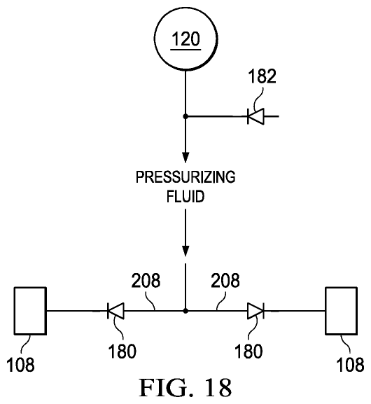

In some embodiments, as may be seen in the embodiment of FIG. 18, a one-way air valve 180 may be used for each tire 108 in air communication with a TIS air source or pressure supply 120. A one-way valve 180 may be disposed in an air conduit 208 unique to a tire 108, and may permit pressurizing air to flow toward or into a tire 108, but not out away from or out of a tire. In some embodiments, a one-way valve may be used in connection with each tire. Thus, if one tire deflates, such as by puncture, the one-way valves may prevent pressurizing air from flowing from one or more inflated tires to the deflated tire. A one-way valve may be disposed, for example, in a rotary union, or in an air conduit between a rotary union and a tire, or in an air conduit between a rotary union and a pressure source.

In some embodiments, as also may be seen in FIG. 18, a TIS having a trailer-mounted or vehicle-mounted air source or pressure supply 120 may also include an air connection 182 connectable to an external air pressure source (not shown). The air connection may simply allow for sealed air communication between an external air pressure source and the pneumatic tires. In other embodiments, the air connection may comprise a one-way valve. In such case, it may be desirable to avoid releasing pressurized air from the TIS through the air connection. Thus, a one-way valve may be used between the trailer- or vehicle-mounted air pressure source and the air connection to allow air to flow from the air connection to the TIS, but not from the TIS through the air connection. In one of a variety of embodiments, a trailer-mounted or vehicle-mounted air source or pressure supply 120 may be omitted from the system, leaving only use of an air connection 182 connectable to an external air pressure source. In such embodiments, an air connection may prevent pressurized air from the TIS from escaping to the atmosphere. In other variations, a trailer-mounted or vehicle-mounted air source or pressure supply 120 may be included from the system, while omitting an air connection 182 connectable to an external air pressure source.

In some embodiments, other sources of providing pressurized fluid may be used other than shown in FIG. 3 or FIGS. 4A-4D. For example, in some embodiments, an RV-mounted pressurized air source or pressure supply 120 may comprise a pressurized air tank or high-pressure compressed gas cylinder. The air tank or gas cylinder may be filled with any suitable tire pressurizing fluid, such as air, nitrogen-enriched air or pure nitrogen. In some of those embodiments, a compressor 112 may not be required to provide suitable fluid pressure to fill the tires 108. For example, air source or pressure supply 120 may maintain stored air at a pressure suitable for delivery without pressure reduction to the tires 108. In other embodiments, such a pressurized air source 120 may hold the air at a pressure that is too high for the trailer tire. A pressure regulator may then be used. Or, controlled or timed delivery of such air to a tire 108 may be used to guarantee that a tire is not overinflated.

Of course, references to “air” with respect to tire inflation should be understood to include any gas or air suitable for inflating a tire, such as pure nitrogen or nitrogen-enriched air.

Although the disclosed embodiments and their advantages have been described in detail, it should be understood that various changes, substitutions and alterations can be made herein without departing from the subject matter defined by the appended claims. Moreover, the scope of the present disclosure is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

1. A tire inflation system for a trailer comprising an axle and pneumatic tires mounted at each end of the axle, the system comprising:
a fluid pressure source mounted to the trailer, the fluid pressure source powerable by energy provided by a tow vehicle or a power source on the trailer;
an electromechanical control system;
wherein a level of condensate in pressurized fluid provided from the fluid pressure source is controllable using said electromechanical control system; and
a fluid pathway providing sealed fluid communication between the fluid pressure source and said pneumatic tires.

2. The tire inflation system of claim 1, the fluid pressure source comprising:
a compressor; and
a tank coupled to the compressor so as to receive said pressurized fluid therefrom, the tank coupled to said fluid pathway.

3. The tire inflation system of claim 1 further comprising:
a shutoff valve disposed along said fluid pathway and configured so as to prevent said pressurized fluid from passing when closed;
a pressure regulator disposed along said fluid pathway and positioned downstream of said shutoff valve to receive the pressurized fluid when the shutoff valve is opened; and
a dryer disposed along said fluid pathway and positioned downstream of said pressure regulator.

4. The tire inflation system of claim 1 further comprising:
a dryer disposed along said fluid pathway between said tank and at least one of said pneumatic tires.

5. The tire inflation system of claim 1 the fluid pressure source being in fluid communication with a liquid drain valve controlled by said electromechanical control system.

6. The tire inflation system of claim 5 the liquid drain valve being controlled by a timer circuit.

7. The tire inflation system of claim 5 the liquid drain valve being controlled by a sensor signal provided in response to detection of water using one or more sensors.

8. The tire inflation system of claim 5, the liquid drain valve being configured to open or close upon actuation of a dump solenoid.

9. The tire inflation system of claim 8, the dump solenoid being controlled by a timer circuit.

10. The tire inflation system of claim 8, the dump solenoid being controlled by a signal provided from one or more sensors.

11. The tire inflation system of claim 8, the dump solenoid being controlled by both a timer circuit and a signal provided from one or more sensors.

12. The tire inflation system of claim 1 further comprising a pressure regulator in sealed communication with the fluid pressure source, wherein the regulator is configured to reduce fluid pressure from the fluid pressure source to a pressure suitable for the pneumatic tires.

13. The tire inflation system of claim 1 further comprising:
a first fluid pathway providing sealed fluid communication between the fluid pressure source and at least one of said pneumatic tires so as to allow pressurized fluid from the fluid pressure source to flow from the fluid pressure source to the at least one of said pneumatic tires; and
a second fluid pathway providing sealed fluid communication between the fluid pressure source and a spare tire of the trailer so as to allow pressurized fluid from the fluid pressure source to flow from the fluid pressure source to the spare tire.

14. The tire inflation system of claim 13 further comprising:
a fluid connector providing sealed fluid communication with the pneumatic tires, the fluid connector comprising a first one-way valve configured for sealed fluid communication with an external fluid pressure source so as to allow fluid to flow from the external fluid pressure source to each of the pneumatic tires, the first one-way valve disposed so as to prevent pressurized fluid from escaping from the fluid connector to atmosphere when the fluid connector is not connected to the external fluid pressure source, the external fluid pressure source being external to both the trailer and the tow vehicle;
a second one-way valve disposed between and in sealed fluid communication with the fluid pressure source and a first pneumatic tire among said pneumatic tires, the second one-way valve disposed so as to allow fluid to flow to the first pneumatic tire and not from the first pneumatic tire to a second pneumatic tire; and
a third one-way valve disposed between and in sealed fluid communication with the fluid pressure source and the second pneumatic tire, the third one-way valve disposed so as to allow fluid to flow to the second pneumatic tire and not from the second pneumatic tire to the first pneumatic tire.

15. The tire inflation system of claim 14, further comprising a fourth one-way valve disposed between and in sealed fluid communication with the fluid pressure source and the spare tire, the fourth one-way valve disposed so as to allow fluid to flow to the spare tire and not from the spare tire to either the first pneumatic tire or the second pneumatic tire.

16. The tire inflation system of claim 14, wherein the fluid pressure source comprises an air compressor and pressurized air tank, and the external pressure source comprises compressed air from one of a maintenance facility, service station or mobile service vehicle.

17. The tire inflation system of claim 1, the axle comprising a torsion axle having at each end thereof a torsion arm and a spindle having one of the pneumatic tires mounted thereto, the spindle having a free end and a fixed end coupled to the torsion arm, the spindle forming a fluid channel extending from the fixed end to the free end along the central long axis of the spindle, the first fluid pathway being sealingly coupled to the first fluid channel, the system further comprising:
a rotary union sealingly coupled to the fluid channel at the free end of the spindle; and
an air hose providing sealed fluid communication between the rotary union and the pneumatic tire mounted to the spindle.

18. The tire inflation system of claim 17, the rotary union further comprising;
a tee body;
a first annular seal circumferentially disposed in the fluid channel;
a second annular seal disposed in the tee body; and
a tubular member sealingly disposed between the first seal and the annular seal.

19. The tire inflation system of claim 18, further comprising a filter disposed at an end of the tubular member.

20. The tire inflation system of claim 18, further comprising a filter disposed at an end of the tubular member.

21. The tire inflation system of claim 17, the rotary union comprising:
a stator sealingly disposed in the axial channel at the free end of the axle spindle;
a first annular seal circumferentially disposed in the stator;
a rotary body;
a second annular seal circumferentially disposed in the rotor body; and
a tubular member sealingly disposed between the first annular seal and the second annular seal.

22. The tire inflation system of claim 1, the fluid pressure source comprising:
a compressor; and
a tank coupled to the compressor so as to receive said pressurized fluid therefrom, the tank coupled to said fluid pathway.
a first temperature sensor disposed so as to detect a temperature of the compressor; and
a first pressure sensor coupled to the tank so as to detect the pressure of fluid in the tank.

23. The tire inflation system of claim 22 wherein said first temperature sensor is disposed so as to enable monitoring of a head temperature of the compressor.

24. The tire inflation system of claim 22 wherein said first temperature sensor is disposed so as to enable monitoring of a compressor motor.

25. The tire inflation system of claim 22 further comprising at least one sensor for detection of residual or standing water.

26. The tire inflation system of claim 22 wherein the at least one sensor comprises a standing water level sensor disposed in a fluid supply line in communication with said tank.

27. The tire inflation system of claim 26 wherein the at least one sensor comprises a capacitance sensor.

28. A tire inflation system for a trailer comprising an axle and pneumatic tires mounted at each end of the axle, the system comprising:
a fluid pressure source mounted to the trailer, the fluid pressure source powerable by energy provided by a tow vehicle or a power source on the trailer;
a first fluid pathway providing sealed fluid communication between the fluid pressure source and at least one of said pneumatic tires so as to allow pressurized fluid from the fluid pressure source to flow from the fluid pressure source to the at least one of said pneumatic tires;
the axle comprising a torsion axle having at each end thereof a torsion arm and a spindle having one of the pneumatic tires mounted thereto, the spindle having a free end and a fixed end coupled to the torsion arm, the spindle forming a fluid channel extending from the fixed end to the free end along the central long axis of the spindle, the fluid channel being sealingly coupled to the first fluid pathway;
a rotary union sealingly coupled to the fluid channel at the free end of the spindle; and
an air hose providing sealed fluid communication between the rotary union and the pneumatic tire mounted to the spindle.

29. The tire inflation system of claim 28, the rotary union further comprising;
a tee body;
a first annular seal circumferentially disposed in the fluid channel;
a second annular seal disposed in the tee body; and
a tubular member sealingly disposed between the first seal and the annular seal.

30. The tire inflation system of claim 29, further comprising a filter disposed at an end of the tubular member.

31. The tire inflation system of claim 29, further comprising a filter disposed at an end of the tubular member.

32. The tire inflation system of claim 28, the rotary union comprising:
a stator sealingly disposed in the axial channel at the free end of the axle spindle;
a first annular seal circumferentially disposed in the stator;
a rotary body;
a second annular seal circumferentially disposed in the rotor body; and
a tubular member sealingly disposed between the first annular seal and the second annular seal.

33. The tire inflation system of claim 28 a second fluid pathway providing sealed fluid communication between the fluid pressure source and a spare tire of the trailer so as to allow pressurized fluid from the fluid pressure source to flow from the fluid pressure source to the spare tire.

34. A tire inflation system for a trailer comprising an axle and pneumatic tires mounted at each end of the axle, the system comprising:
a fluid pressure source mounted to the trailer, the fluid pressure source powerable by energy provided by a tow vehicle or a power source on the trailer;
a first fluid pathway providing sealed fluid communication between the fluid pressure source and at least one of said pneumatic tires so as to allow pressurized fluid from the fluid pressure source to flow from the fluid pressure source to the at least one of said pneumatic tires;
a second fluid pathway providing sealed fluid communication between the fluid pressure source and a spare tire of the trailer so as to allow pressurized fluid from the fluid pressure source to flow from the fluid pressure source to the spare tire.

35. The system of claim 34, further comprising a fluid connector providing sealed fluid communication with the pneumatic tires, the fluid connector comprising a first one-way valve configured for sealed fluid communication with an external fluid pressure source so as to allow fluid to flow from the external fluid pressure source to each of said pneumatic tires, the first one-way valve disposed so as to prevent pressurized fluid from escaping from the fluid connector to atmosphere when the fluid connector is not connected to the external fluid pressure source, the external fluid pressure source being external to both the trailer and the tow vehicle.

36. The system of claim 34 further comprising a pressure-relief valve (PRV) in sealed communication with the pneumatic tires, wherein the PRV is configured to release fluid when the fluid pressure in the pneumatic tires reaches a pressure threshold.

37. The system of claim 34 further comprising a pressure regulator in sealed communication with the fluid pressure source, wherein the regulator is configured to reduce fluid pressure from the fluid pressure source to a pressure suitable for the pneumatic tires.

38. The system of claim 34 further comprising:
a second one-way valve disposed between and in sealed fluid communication with the fluid pressure source and a first pneumatic tire among said pneumatic tires, the second one-way valve disposed so as to allow fluid to flow to the first pneumatic tire and not from the first pneumatic tire to a second pneumatic tire among said pneumatic tires; and
a third one-way valve disposed between and in sealed fluid communication with the fluid pressure source and the second pneumatic tire, the third one-way valve disposed so as to allow fluid to flow to the second pneumatic tire and not from the second pneumatic tire to the first pneumatic tire.

39. The system of claim 38, further comprising a fourth one-way valve disposed between and in sealed fluid communication with the fluid pressure source and the spare tire, the third one-way valve disposed so as to allow fluid to flow to the spare tire and not from the spare tire to either the first pneumatic tire or the second pneumatic tire.

40. The system of claim 34, wherein the fluid pressure source comprises an air compressor and pressurized air tank, and the external pressure source comprises compressed air from one of a maintenance facility, service station or mobile service vehicle.

41. The system of claim 34, the axle comprising a torsion axle having at each end thereof a torsion arm and a spindle having one of the pneumatic tires mounted thereto, the spindle having a free end and a fixed end coupled to the torsion arm, the spindle forming a fluid channel extending from the fixed end to the free end along the central long axis of the spindle, the fluid conduit being sealingly coupled to the fluid channel, the system further comprising:
a rotary union sealingly coupled to the fluid channel at the free end of the spindle; and
an air hose providing sealed fluid communication between the rotary union and the pneumatic tire mounted to the spindle.

42. The system of claim 41, the rotary union further comprising;
a tee body;
a first annular seal circumferentially disposed in the fluid channel;
a second annular seal disposed in the tee body; and
a tubular member sealingly disposed between the first seal and the annular seal.

43. The system of claim 42, wherein the tubular member is rigid.

44. The system of claim 42, wherein the tubular member is flexible.

45. The system of claim 42, wherein the tubular member comprises a rigid portion and a flexible portion.

46. The system of claim 42, wherein the tubular member is rotatably and translatably disposed in both the first annular seal and the second annular seal.

47. The system of claim 42, wherein the second annular seal is circumferentially disposed in the tee body, and the tubular member is rotatably and translatably disposed in one of the first annular seal and the second annular seal.

48. The system of claim 42, further comprising a filter disposed at an end of the tubular member.

49. The system of claim 42, further comprising a filter disposed in the tubular member.

50. The system of claim 42, wherein the first annular seal is an elastomeric o-ring and the second annular seal is a lip seal.

51. The system of claim 42, wherein the first annular seal is an elastomeric o-ring and the second annular seal is an elastomeric o-ring.

52. The system of claim 42, wherein the first annular seal is a lip seal and the second annular seal is an elastomeric o-ring.

53. The system of claim 42, wherein the first annular seal is a lip seal and the second annular seal is a lip seal.

54. The system of claim 41, the rotary union comprising a body portion rotatable with respect to the axle spindle, and a stator portion non-rotatable with respect to the axle spindle, the stator portion being in sealed fluid communication with the fluid channel.

55. The system of claim 41, the rotary union comprising a non-rotating steel portion and an abutting rotatable graphite portion, the steel portion and the graphite portion forming a face seal.

56. The system of claim 41, further comprising a fluid filter disposed between the pressurized fluid supply and the rotary union.

57. The system of claim 41, further comprising a fluid hose providing sealed fluid communication between the rotary union and the tire.

58. The system of claim 41, further comprising tubing providing sealed fluid communication between the rotary union and the pressurized fluid supply.

59. The system of claim 41, further comprising tubing providing sealed fluid communication to the axial channel at the fixed end of the axle spindle.

60. The system of claim 59, further comprising a fitting connecting the tubing to the inner face, the fitting comprising a fluid filter.

61. The system of claim 41, the rotary union comprising:
a stator sealingly disposed in the axial channel at the free end of the axle spindle;
a first annular seal circumferentially disposed in the stator;
a rotary body;
a second annular seal circumferentially disposed in the rotor body; and
a tubular member sealingly disposed between the first annular seal and the second annular seal.

62. The system of claim 61, wherein the rotary body is mounted to the exterior of a hubcap.

63. The system of claim 61, wherein the rotary body is mounted to the interior of a hubcap.

64. The system of claim 61, wherein the rotary body comprises a hubcap.

65. The system of claims 58-60, the spindle having a threaded hub mounted thereto, the hubcap being threaded so as to be cooperatively secured to the threaded hub.

66. The system of claim 61, wherein the tubular member is rigid.

67. The system of claim 61, wherein the tubular member is flexible.

68. The system of claim 61, wherein the tubular member comprises a rigid portion and a flexible portion.

69. The system of claim 61, wherein the first annular seal is an elastomeric o-ring and the second annular seal is a lip seal.

70. The system of claim 61, wherein the first annular seal is an elastomeric o-ring and the second annular seal is an elastomeric o-ring.

71. The system of claim 61, wherein the first annular seal is a lip seal and the second annular seal is an elastomeric o-ring.

72. The system of claim 61, wherein the first annular seal is a lip seal and the second annular seal is a lip seal.

73. The system of claim 61, wherein the tubular member is rotatably and translatably disposed in both the first annular seal and the second annular seal.

74. The system of claim 61, wherein the second annular seal is circumferentially disposed in the tee body, and the tubular member is rotatably and translatably disposed in one of the first annular seal and the second annular seal.

75. The system of claim 61, wherein the stator is in fluid communication with the pressurized fluid supply through a fluid conduit.

76. A method of providing a tire inflation system for a trailer comprising an axle having a spindle at each end, the trailer not being equipped with air brakes, the method comprising forming an axial channel along the central axis of a spindle, the axial channel terminating at a free end of the spindle.

77. The method of claim 76, the spindle having a wheel end assembly rotatably mounted thereto, the method further comprising mounting a rotary union to said wheel end assembly so as to place the rotary union in sealed fluid communication with the axial channel.

78. The method of claim 77, the wheel end assembly comprising a pneumatic tire, the method further comprising connecting an air hose between the rotary union and the pneumatic tire.

79. The method of claim 78, further comprising sealingly disposing a stator portion of the rotary union in the axial channel at the free end of the spindle.

80. The method of claim 79, further comprising providing sealed fluid communication from the rotary union to a pressurized fluid supply through the axial channel.

81. The method of claim 76, wherein the axial channel is formed by drilling.

82. The method of claim 76, further comprising mounting the rotary union to a hubcap.

83. The method of claim 76, wherein the rotary union is part of a hubcap.

84. The method of claim 76, the axle comprising a torsion axle having at each end an axle arm and a spindle having a free end and a fixed end mounted to the axle arm, the axial channel extending along the entire length of the spindle, the method further comprising:
mounting the rotary union in sealed fluid communication with the axial channel at the free end of the axle spindle; and
providing a fluid conduit in sealed fluid communication with the axial channel at the fixed end of the spindle and with a pressurized fluid supply.

85. The method of claim 84, further comprising mounting the rotary union in sealed fluid communication with the pressurized fluid supply through a fluid conduit extending through the axial channel.

86. The method of claim 85 further comprising:
disposing a non-rotatable portion of the rotary union in sealed communication with a pressurized fluid supply; and
disposing a rotatable portion of the rotary union in sealed communication with a pneumatic tire.

87. The method of claim 86, wherein the rotary union comprises a tubular member, the method further comprising:
disposing an annular seal circumferentially in the axial channel near the free end of the axle spindle; and
sealingly disposing the tubular member in the annular seal.

88. The method of claim 87, wherein the tubular member is rotatably disposed in the annular seal.

89. The method of claim 87, wherein the tubular member is translatably disposed in the annular seal.

90. The method of claim 77, wherein the rotary union comprises a first annular member having a tubular member sealingly disposed therein, the method further comprising:
disposing a second annular seal circumferentially in the axial channel near the free end of the spindle; and
sealingly disposing the tubular member in the second annular seal.

91. The method of claim 90, wherein the tubular member is rotatably disposed in either the first annular seal or in the second annular seal.

92. The method of claim 90, wherein the tubular member is rotatably disposed in both the first annular seal and in the second annular seal.

93. The method of claim 90, wherein the rotary union comprises a rotatable graphite portion and the tubular member comprises a steel portion, the rotatable graphite portion and the steel portion abutting to form a face seal; and the tubular member is non-rotatingly disposed in the annular seal.

94. The method of claim 76 further comprising forming a counterbore in the axial channel at the free end of the spindle, the counterbore being configured to sealingly receive a portion of a tool-adapted portion of a stator of a rotary union.

95. The method of claim 76 further comprising forming a counterbore in the axial channel at the free end of the spindle, the counterbore being configured to sealingly receive the entire tool-adapted portion of a stator of a rotary union.

96. The method of claim 95, the spindle being adapted for rotatable mounting of a hub thereto, the method further comprising:
threading the hub to receive a threaded hubcap;
mounting a rotor body of the rotary union to the hubcap, the rotor body comprising a tubular member extending therefrom;
inserting the tubular member into the stator; and
threadably coupling the hubcap to the hub.

97. The method of claim 96, the hubcap being configured such that the rotor body is disposed partially within the outboard plane of a tire and wheel mounted to the hub.

98. The method of claim 96, the hubcap being configured such that the rotor body is disposed wholly within the outboard plane of a tire and wheel mounted to the hub.

99. A hubcap for a trailer not being equipped with air brakes, the hubcap comprising a hollow body having a first end enclosed by a face and having a second end open and adapted for coupling to a hub of the trailer by screw threading, bolt, retainer ring, friction fit or twist lock.

100. The hubcap of claim 99 further comprising an annular seal disposed at the second end so as to seal the hubcap to the hub when the hubcap is coupled to the hub.

101. The hubcap of claim 99 further comprising a threaded bore formed at the center of the face, the threaded bore being configured to receive a rotary union body.

102. The hubcap of claim 101, the face having a vent aperture formed therein.

103. The hubcap of claim 102, the face having a plurality of vent apertures formed therein.

104. The hubcap of claim 103, the plurality of vent apertures disposed about the threaded bore so as to be covered by a shield of the rotary union body.

105. A tire inflation system for a trailer comprising an axle and a pneumatic tire mounted at each end of the axle, the trailer not being equipped with air brakes, the system comprising:
a fluid pressure source mounted to the trailer, the fluid pressure source powerable by energy provided by the vehicle or a power source on the trailer;
a fluid conduit providing sealed fluid communication between the fluid pressure source and each pneumatic tire so as to allow pressurized fluid from the trailer-mounted fluid pressure source to flow from the fluid pressure source to each pneumatic tire; and
an auxiliary conduit providing sealed fluid communication between the fluid pressure source and an auxiliary air connection.

106. The system of claim 105, the fluid pressure source comprising:
an air compressor;
an air tank coupled to the air compressor so as to receive compressed air therefrom, the air tank coupled to the fluid conduit and the auxiliary conduct so as to deliver pressurized air there through;
a first temperature sensor disposed so as to detect the temperature of the air compressor; and
a first pressure sensor coupled to the air tank so as to detect the pressure of air in the air tank.

107. The system of claim 106, the air tank comprising a liquid drain valve, the drain valve being configured to open an close upon actuation of a dump solenoid.

108. The system of claim 107, the dump solenoid being controllable by a timer.

109. The system of claim 107, further comprising:
a shutoff valve disposed so as to prevent pressurized air from passing when closed;
a pressure regulator disposed to receive the pressurized air from the shutoff valve;
an air dryer disposed so as to receive the pressurized air from the pressure regulator and pass the pressurized air to each pneumatic tire.

110. The system of claim 109, the air dryer disposed so as to pass the pressurized air to a spare tire.

111. The system of claim 110, further comprising a second temperature sensor configured to detect temperature inside the spare tire.

112. The system of claim 110, further comprising a pressure temperature sensor configured to detect pressure inside the spare tire.

113. The system of claim 110, further comprising a combined pressure and temperature sensor configured to detect temperature and pressure inside the spare tire.

114. The system of claim 110, further comprising a second temperature sensor configured to detect temperature inside one of the pneumatic tires.

115. The system of claim 110, further comprising a pressure temperature sensor configured to detect pressure inside one of the pneumatic tires.

116. The system of claim 110, further comprising a combined pressure and temperature sensor configured to detect temperature and pressure inside one of the pneumatic tires.

117. The system of claim 106, the air compressor being controlled by a compressor solenoid, the compressor solenoid being actuated based on a signal from a pressure switch.
